(19) United States
(12) Patent Application Publication
(10) Pub. No.: US 2026/0183940 A1
(43) Pub. Date: Jul. 2, 2026

(54) ROBOT COMPLIANCE CONTROL METHOD, SYSTEM, AND APPARATUS WITH PARAMETER SELF-LEARNING

(71) Applicant: Zhejiang University of Technology, Hangzhou (CN)

(72) Inventors: Hui DONG, Hangzhou (CN); Xiang WU, Hangzhou (CN); Guangpu HUANG, Hangzhou (CN); Wenjie LIN, Hangzhou (CN); Dingkun LIANG, Hangzhou (CN); Mincheng WU, Hangzhou (CN); Wenan ZHANG, Hangzhou (CN)

(21) Appl. No.: 19/295,730

(22) Filed: Aug. 11, 2025

(30) Foreign Application Priority Data
Dec. 31, 2024 (CN) 202411978778.X

(51) Int. Cl. B25J 9/16

(52) U.S. Cl. CPC B25J 9/163; B25J 9/1633; B25J 9/1661

(57) ABSTRACT

The present disclosure discloses a robot compliance control method, system, and apparatus with parameter self-learning capabilities. The method includes constructing a joint dynamics model and a joint impedance control model for a robot to obtain an unknown dynamic model of the robot; constructing a Gaussian process with a structure consistent with the unknown dynamic model, denoted as a structure-consistent Gaussian process; constructing a training set based on a data optimization method, and training hyperparameters of the structure-consistent Gaussian process offline using the training set; observing a robot state in real-time, predicting an unknown dynamic model online, and outputting a Gaussian prediction value for the unknown dynamic model; outputting a control moment through a robot joint impedance controller and sending the control moment to the robot; and determining whether the robot has reached a desired position; if yes, ending; otherwise, continuing to observe the robot state.

### CROSS-REFERENCE TO RELATED APPLICATIONS

The present disclosure claims priority to Chinese Patent Application No. 202411978778.X, entitled “ROBOT COMPLIANCE CONTROL METHOD, SYSTEM, AND APPARATUS WITH PARAMETER SELF-LEARNING” filed on Dec. 31, 2024, which is incorporated by reference herein in its entirety.

### TECHNICAL FIELD

The present disclosure relates to the field of robot control, and more particularly, to a robot compliance control method, system, and apparatus with parameter self-learning.

### BACKGROUND

With the continuous advancement of the robot technology, robots have been widely applied in various contact tasks, such as massage, human-robot interaction, and polishing. In unstructured environments, the robots are not only required to have high-precision motion control capabilities, but also are required to significantly improve compliance performances to ensure the efficiency and effectiveness of contact operations, while also ensuring safety during the interaction process.

An impedance control method, as one of the fundamental control methods for the robots to handle complex contact tasks, relies on precise dynamic parameters of the robot for applications. However, it is difficult to obtain the dynamic parameters of the robot in practical operations. Therefore, intelligent impedance control methods that incorporate learning technologies to deal with unknown dynamic models of the robots are gradually becoming the focus of research.

An adaptive impedance control method is one of the most popular methods for handling unknown robot dynamics. The key idea of the adaptive impedance control method is to design an appropriate adaptive law to estimate parameters for the dynamic model of the robot. Then, an impedance controller uses the estimated parameters to ensure a stability of a closed-loop robot system and a convergence of a parameter estimator using a Lyapunov's theorem. According to the estimation target, the adaptive impedance control methods are divided into four types. The first type directly designs an adaptive law for the parameters of the dynamic model of the robot, namely, an inertia, a Coriolis/centrifugal matrix, and a gravity vector of the robot. However, due to the diversity of the estimated parameters, this type of adaptive control law can be quite complex. The second type is based on the property that the dynamic model of the robot can be expressed in a linear form, namely, a base matrix being multiplied by a weight parameter. However, collecting the base matrix can be very complex. The third type estimates various bounds of the parameters of the dynamic model. Compared to the previous type, the estimated parameters in this type are scalars, which reduces the complexity of estimation and may accelerate the convergence rate. The fourth type uses neural networks to fit the unknown part of the robot dynamics, wherein weight parameters of the neural networks are estimated through an adaptive law. Due to the powerful fitting ability of the neural networks, the neural networks can be used to fit different parts of the robot dynamics, thus different neural network-based adaptive impedance control methods can be proposed.

Although the adaptive impedance control method employs the adaptive techniques to estimate the dynamic parameters of the robot, the primary goal of parameter adaptation is not to reduce estimation error but to ensure the stability of the closed-loop system. Therefore, the adaptive control law lacks intuition, potentially limiting dynamic control accuracy. A more intuitive and effective approach is to directly use a regression method to fit unknown robot dynamics and utilize the fitting results for impedance control. Due to the flexibility and ability to provide predictive uncertainty, a Gaussian Process (GP) has become popular in capturing unknown robot dynamics for robot control. Therefore, it is particularly important to predict the dynamic model of the robot using the GP to achieve high-precision robot control. However, most GP-based methods do not consider the special structure of the dynamic model of the robot during learning, which can affect the reliability of learning to some extent and reduce the accuracy and stability of robot control. Therefore, considering the special structure of the dynamic model the robot, it is of great significance to design a GP that is consistent with the structure of the dynamic model to learn unknown dynamic models.

### SUMMARY

The present disclosure aims to provide a robot compliance control method, system, and apparatus with parameter self-learning, which can achieve high-precision robot control.

The technical solutions adopted in the present disclosure are as follows.

According to a first aspect, the present disclosure provides a robot compliance control method with parameter self-learning, including steps of:
constructing a joint dynamics model and a joint impedance control model for a robot, and obtaining an unknown dynamic model of the robot;
constructing a Gaussian process with a structure consistent with the unknown dynamic model of the robot, denoted as a structure-consistent Gaussian process;
constructing a training set based on a data optimization method, and training hyperparameters of the structure-consistent Gaussian process offline using the training set;
observing a robot state in real-time, predicting the unknown dynamic model of the robot online through the structure-consistent Gaussian process, and outputting a Gaussian prediction value of the unknown dynamic model;
based on the Gaussian prediction value of the unknown dynamic model, outputting a control moment through a joint impedance controller of the robot and sending the control moment to the robot; and
determining whether the robot has reached a desired position, if yes, ending; otherwise, continuing to observe the robot state.

In some embodiments, the step of constructing a joint dynamics model and a joint impedance control model for a robot, and obtaining an unknown dynamic model of the robot includes:
constructing the joint dynamics model for the robot with n degrees of freedom as follows:

$$H ( q ) \ddot{q} + C ( q , \dot{q} ) \dot{q} + g ( q ) + {τ}_{f} ( \dot{q} ) = τ + {τ}_{e} ;$$

wherein, q, \dot{q}, \ddot{q}∈Rⁿ respectively represent the position, the velocity, and an acceleration of the robot joint, H(q)∈R^{n×n} represents an inertia matrix of the robot, C(q,\dot{q})∈R^{n×n} represents a Coriolis force and centrifugal force matrix of the robot, g(q)∈Rⁿ represents a gravitational moment of the robot, τ_{f}(\dot{q})∈Rⁿ represents a friction torque of the robot, τ∈Rⁿ, τₑ∈Rⁿ respectively represent the control moment and a contact moment of the robot, Rⁿ represents a n-dimensional vector, R^{n×n} represents a n×n matrix;
constructing the joint impedance control model as follows:

$$\{ \begin{matrix}\overline{H} ë + \overline{D} \dot{e} + \overline{K} e = {τ}_{e} \\ e = q - {q}_{d}\end{matrix} ;$$

wherein, H̅, D̅, K̅ respectively represent an inertia matrix, a damping matrix, and a stiffness matrix in the joint impedance control model; e, ė, ë respectively represent a position error, a velocity error, and an acceleration error of the robot joint; q_{d} represents a desired trajectory of the robot joint; therefore:

$$\ddot{q} = {\overline{H}}^{{}_{- 1}} ( {τ}_{e} - \overline{K} e - \overline{D} \dot{e} ) + {\ddot{q}}_{d} ;$$

wherein, \ddot{q}_{d} represents a desired acceleration of the robot joint, and an impedance control rate of the robot joint is obtained as follows:

$$\{ \begin{matrix}τ = {τ}_{fb} + {τ}_{ff} \\ {τ}_{fb} = H ( q ) \overline{H} ( {τ}_{e} - \overline{K} e - ( \overline{D} - \overline{H} {H ( q )}^{- 1} C ( q , \dot{q} ) ) \dot{e} ) \\ {τ}_{ff} = g ( q ) + {τ}_{f} ( \dot{q} ) + H ( q ) {\ddot{q}}_{d} + C ( q , \dot{q} ) {\dot{q}}_{d}\end{matrix} ;$$

wherein, τ_{fb}, τ_{ff} respectively represent components containing impedance parameters and the unknown dynamic model; \dot{q}_{d} is the desired velocity of the robot joint; by setting:

$$\{ \begin{matrix}\overline{H} = H ( q ) \\ \overline{D} = C ( q , \dot{q} ) + D \\ \overline{K} = K\end{matrix} ;$$

wherein, D and K are constant matrices, the following formula is obtained:

$${τ}_{fb} = - Ke - D \dot{e} ;$$

wherein, Ĥ(q), Ĉ(q,\dot{q}), \hat{τ}_{f}(\dot{q}) respectively represent nominal values of H(q), C(q,\dot{q}), τ_{f}(\dot{q}), then τ_{ff} is rewritten as:

$${τ}_{ff} = g ( q ) + \hat{H} ( q ) {\ddot{q}}_{d} + \hat{C} ( q , \dot{q} ) ) {\dot{q}}_{d} + {\hat{τ}}_{f} ( q ) + μ ;$$

wherein, μ represents the unknown dynamic model of the robot, expressed as:

$$\{ \begin{matrix}μ = {μ}_{H} + {μ}_{C} + {μ}_{f} \\ {μ}_{H} = ( H ( q ) - \hat{H} ( q ) ) {\ddot{q}}_{d} \\ {μ}_{C} = ( C ( q , \dot{q} ) - \hat{C} ( q , \dot{q} ) ) {\dot{q}}_{d} \\ {μ}_{f} = {τ}_{f} - {\hat{τ}}_{f}\end{matrix} ;$$

wherein, μ_{H}, μ_{C}, μ_{f} respectively represent an inertial force component, a Coriolis force component, and a frictional force component in the unknown dynamic model of the robot; furthermore, the unknown dynamic model of the robot satisfies the following structure:

$$\{ \begin{matrix}{μ}_{H} ( q , {0}_{n \times 1} ) = {0}_{n \times 1} \\ {μ}_{C} ( q , {0}_{n \times 1} , {\dot{q}}_{d} ) = {μ}_{C} ( q , \dot{q} , {0}_{n \times 1} ) = {0}_{n \times 1} \\ {μ}_{f} ( {0}_{n \times 1} ) = {0}_{n \times 1}\end{matrix} ;$$

from the above formula, when an input, \ddot{q}_{d}=0, μ_{H}=0; when \dot{q}_{d}=0 or \dot{q}=0, μ_{C}=0; when \dot{q}=0, μ_{f}=0.

In some embodiments, the structure-consistent Gaussian process is constructed as follows:
since an inertial force μ_{H}, a Coriolis force μ_{C}, and a frictional force μ_{f} in the unknown dynamic model of the robot all have n dimensions, n independent Gaussian processes are designed to respectively predict each dimension of μ_{H}, μ_{C}, μ_{f}.

Three parameters are defined as:

$${ξ}_{H}^{T} = [ \begin{matrix}{q}^{T} & {\ddot{q}}_{d}^{T}\end{matrix} ] , {ξ}_{C}^{T} = [ \begin{matrix}{q}^{T} & \dot{q} & {\dot{q}}_{d}^{T}\end{matrix} ] ,$$

and ξ_{f}=\dot{q}, and μ_{H}, μ_{C}, μ_{f} are set to follow the following Gaussian distributions respectively:

$$\{ \begin{matrix}{μ}_{H} ∼ GP ( 0 , k ( {ξ}_{H} , {ξ}_{H}^{′} ) ) \\ {μ}_{C} ∼ GP ( 0 , k ( {ξ}_{C} , {ξ}_{C}^{′} ) ) \\ {μ}_{f} ∼ GP ( 0 , k ( {ξ}_{f} , {ξ}_{f}^{′} ) )\end{matrix} ;$$

wherein, GP(·) represents a Gaussian distribution, T represents a transpose operation of a matrix, q represents a position of a robot joint, \dot{q} represents a desired velocity of the robot, \dot{q}_{d} represents a velocity of the robot joint, joint, \ddot{q}_{d} represents a desired acceleration of the robot joint, k(·) represents a variance,

$${ξ}_{H}^{′} , {ξ}_{C}^{′} , and {ξ}_{f}^{′}$$

respectively represent inputs corresponding to the inertial force, the Coriolis force, and the frictional force from the training set,

$$k ( {ξ}_{H} , {ξ}_{H}^{′} )$$

represents a variance of the inertial force in the unknown dynamic model,

$$k ( {ξ}_{C} , {ξ}_{C}^{′} )$$

represents a variance of the Coriolis force in the unknown dynamic model,

$$k ( {ξ}_{f} , {ξ}_{f}^{′} )$$

represents a variance of the frictional force in the unknown dynamic model, and

$$k ( {ξ}_{H} , {ξ}_{H}^{′} ) , k ( {ξ}_{C} , {ξ}_{C}^{′} ) , and k ( {ξ}_{f} , {ξ}_{f}^{′} )$$

are expressed as:

$$\{ \begin{matrix}k ( {ξ}_{H} , {ξ}_{H}^{′} ) = E [ μ ( {ξ}_{H} ) μ ( {ξ}_{H}^{′} ) ] \\ k ( {ξ}_{C} , {ξ}_{C}^{′} ) = E [ μ ( {ξ}_{C} ) μ ( {ξ}_{C}^{′} ) ] \\ k ( {ξ}_{f} , {ξ}_{f}^{′} ) = E [ μ ( {ξ}_{f} ) μ ( {ξ}_{f}^{′} ) ]\end{matrix} ;$$

wherein, E[·] represents a desired value, and μ(·) represents a mean;
the inertial force μ_{H}, the Coriolis force μ_{C}, and the frictional force μ_{f} are set to be mutually independent, that is, a covariance of the inertial force μ_{H}, a covariance of the Coriolis force μ_{C}, and a covariance of the frictional force μ_{f} are set to be all 0:

$$\{ \begin{matrix}Cov ( μ ( {ξ}_{H} ) , μ ( {ξ}_{C} ) ) = E [ μ ( {ξ}_{H} ) μ ( {ξ}_{C}^{′} ) ] = 0 \\ Cov ( μ ( {ξ}_{H} ) , μ ( {ξ}_{f} ) ) = E [ μ ( {ξ}_{H} ) μ ( {ξ}_{f}^{′} ) ] = 0 ; \\ Cov ( μ ( {ξ}_{C} ) , μ ( {ξ}_{f} ) ) = E [ μ ( {ξ}_{C} ) μ ( {ξ}_{f}^{′} ) ] = 0\end{matrix}$$

wherein, Cov(·) represents the covariance, then a variance function of a compensation term μ is:

$$k ( ξ , {ξ}^{′} ) = E [ μ ( ξ ) μ ( {ξ}^{′} ) ] = k ( {ξ}_{H} , {ξ}_{H}^{′} ) + k ( {ξ}_{C} , {ξ}_{C}^{′} ) + k ( {ξ}_{f} , {ξ}_{f}^{′} ) ;$$

wherein, ξ and ξ′ respectively represent an actual input value and an input of the unknown dynamic model from the training set;
similarly, Cov(μ(ξ_{H}), μ(ξ′)), Cov(μ(ξ_{C}), μ(ξ′), Cov(μ(ξ_{f}), μ(ξ′)) are respectively:

$$\{ \begin{matrix}Cov ( μ ( {ξ}_{H} ) , μ ( {ξ}^{′} ) ) = k ( {ξ}_{H} , {ξ}_{H}^{′} ) \\ Cov ( μ ( {ξ}_{C} ) , μ ( {ξ}^{′} ) ) = k ( {ξ}_{C} , {ξ}_{C}^{′} ) \\ Cov ( μ ( {ξ}_{f} ) , μ ( {ξ}^{′} ) ) = k ( {ξ}_{f} , {ξ}_{f}^{′} )\end{matrix} ;$$

therefore, for a priori ξ*, a joint probability distribution is obtained as follows:

$$p ( [ \begin{matrix}μ ( {ξ}_{H}^{*} ) \\ μ ( {ξ}_{C}^{*} ) \\ μ ( {ξ}_{f}^{*} ) \\ y\end{matrix} ] [ \begin{matrix}{ξ}^{*} \\ Ξ\end{matrix} ] ) = ℕ ( [ \begin{matrix}0 \\ 0 \\ 0 \\ \text{?}\end{matrix} ] , [ \begin{matrix}{k}_{H}^{*} & 0 & 0 & {\vec{k}}_{H} ( {ξ}_{H}^{*} ) \\ 0 & {k}_{C}^{*} & 0 & {\vec{k}}_{C} ( {ξ}_{C}^{*} ) \\ 0 & 0 & {k}_{f}^{*} & {\vec{k}}_{f} ( {ξ}_{f}^{*} ) \\ {\vec{k}}_{H} ( {ξ}_{H}^{*} ) & {\vec{k}}_{C} ( {ξ}_{C}^{*} ) & {\vec{k}}_{f} ( {ξ}_{f}^{*} ) & K + {σ}^{2} I\end{matrix} ] ) ;$$

$$\text{?} \text{indicates text missing or illegible when filed}$$

wherein, p(·) represents a probability,

$${ξ}_{H}^{*}$$

represents a priori of the inertial force of the unknown dynamic model,

$${ξ}_{C}^{*}$$

represents a priori of the Coriolis force of the unknown dynamic model,

$${ξ}_{f}^{*}$$

represents a priori of the frictional force of the unknown dynamic model,

$$μ ( {ξ}_{H}^{*} )$$

is a mean of the priori of the inertial force,

$${ξ}_{H}^{*}$$

represents a mean of the priori of the Coriolis force,

$$μ ( {ξ}_{C}^{*} )$$

represents a mean of the priori of the frictional force, Ξ represents the training set, y represents an output, [symbol] (·) represents the Gaussian distribution, N represents a length of position data of the robot,

$${k}_{H}^{*} ,$$

$${k}_{f}^{*}$$

$$and$$

$${k}_{C}^{*}$$

respectively represent priori kernel function values corresponding to the inertial force, the Coriolis force, and the frictional force;

$${\vec{k}}_{H} ( {ξ}_{H}^{*} ) ,$$

$${\vec{k}}_{C} ( {ξ}_{C}^{*} ) ,$$

$$and$$

$${\vec{k}}_{f} ( {ξ}_{f}^{*} )$$

respectively represent kernel function vectors corresponding to the inertial force, the Coriolis force, and the frictional force, K represents a kernel function matrix, σ represents a noise variance, I represents an identity matrix,

$${k}_{H}^{*} {=}^{Δ} k ( {ξ}_{H}^{*} , {ξ}_{H}^{*} ) ,$$

$${{\vec{k}}_{H} ( {ξ}_{H}^{*} )}_{i} = k ( {ξ}_{H}^{*} , {ξ}_{i} ) ,$$

ξᵢ represents i-th data in the training set,

$${{\vec{k}}_{H} ( {ξ}_{H}^{*} )}_{i}$$

represents the kernel function value corresponding to ξᵢ, and Ξ represents the training set, thus:

$$p ( [ \begin{matrix}μ ( {ξ}_{H}^{*} ) \\ μ ( {ξ}_{C}^{*} ) \\ μ ( {ξ}_{f}^{*} )\end{matrix} ] \text{?} {ξ}^{*} , y , Ξ ) = ℕ ( [ \begin{matrix}{µ}_{H , GP} ( {ξ}_{H}^{*} ) \\ {µ}_{C , GP} ( {ξ}_{C}^{*} ) \\ {µ}_{f , GP} ( {ξ}_{f}^{*} )\end{matrix} ] , {Q}_{GP , HCf}^{2} ( {ξ}^{*} ) ) ;$$

$$\text{?} \text{indicates text missing or illegible when filed}$$

wherein,

$${μ}_{H , G F} ( {ξ}_{H}^{*} )$$

represents a Gaussian prediction value of the inertial force in the unknown dynamic model,

$${μ}_{C , G F} ( {ξ}_{C}^{*} )$$

represents a Gaussian prediction
value of the Coriolis force in the unknown dynamic model,

$${μ}_{f , G P} ( {ξ}_{f}^{*} )$$

represents a Gaussian prediction value of the frictional force in the unknown dynamic model,

$${σ}_{GP , HCf}^{2} ( {ξ}^{*} )$$

represents the joint variance, wherein:

$$\{ \begin{matrix}{μ}_{H , G P} ( {ξ}_{H}^{*} ) = {{\vec{k}}_{H} ( {ξ}_{H}^{*} )}^{T} {( K + {σ}^{2} I )}^{- 1} y \\ {μ}_{C , GP} ( {ξ}_{C}^{*} ) = {{\vec{k}}_{C} ( {ξ}_{C}^{*} )}^{T} {( K + {σ}^{2} I )}^{- 1} y \\ {μ}_{f , G P} ( {ξ}_{f}^{*} ) = {{\vec{k}}_{f} ( {ξ}_{f}^{*} )}^{T} {( K + {σ}^{2} I )}^{- 1} y\end{matrix} ;$$

therefore, a Gaussian process prediction of the unknown dynamic model μ is:

$${μ}_{G P} ( {ξ}^{*} ) = {μ}_{H , GP} ( {ξ}_{H}^{*} ) + {μ}_{C , G P} ( {ξ}_{C}^{*} ) + {μ}_{f , G P} ( {ξ}_{f}^{*} ) = {\vec{k} ( {ξ}^{*} )}^{T} {( K + {σ}^{2} I )}^{- 1} y ;$$

wherein, μ_{GP}(ξ*) represents the Gaussian prediction value of the unknown dynamic model, and \vec{k}(ξ*) represents a Gaussian prediction variance of the unknown dynamic model;
kernel functions

$$k ( {ξ}_{H} , {ξ}_{H}^{′} ) , k ( {ξ}_{C} , {ξ}_{C}^{′} ) , k ( {ξ}_{f} , {ξ}_{f}^{′} )$$

are respectively designed for the inertial force μ_{H}, the Coriolis force μ_{C}, and the frictional force μ_{f} as follows:

$$\{ \begin{matrix}k ( {ξ}_{H} , {ξ}_{H}^{′} ) = {c}_{H} ( {ξ}_{H} ) {\overline{k}}_{H} ( {ξ}_{H} , {ξ}_{H}^{′} ) {c}_{H} ( {ξ}_{H} ) \\ {\overline{k}}_{H} ( {ξ}_{H} , {ξ}_{H}^{′} ) = {σ}_{H}^{2} exp \{ - {( {ξ}_{H} - {ξ}_{H}^{′} )}^{T} {Λ}_{H}^{- 1} ( {ξ}_{H} - {ξ}_{H}^{′} ) \} \\ {c}_{H} ( {ξ}_{H} ) = tanh ( {α}_{H}^{2} {‖ {\ddot{q}}_{d} ‖}^{2} )\end{matrix} ;$$

$$\{ \begin{matrix}k ( {ξ}_{C} , {ξ}_{C}^{′} ) = {c}_{C} ( {ξ}_{C} ) {\overline{k}}_{C} ( {ξ}_{C} , {ξ}_{C}^{′} ) {c}_{C} ( {ξ}_{C} ) \\ {\overline{k}}_{C} ( {ξ}_{C} , {ξ}_{C}^{′} ) = {σ}_{C}^{2} exp \{ - {( {ξ}_{C} - {ξ}_{C}^{′} )}^{T} {Λ}_{C}^{- 1} ( {ξ}_{C} - {ξ}_{C}^{′} ) \} \\ {c}_{C} ( {ξ}_{C} ) = tanh ( {α}_{C}^{2} {‖ \dot{q} ‖}^{2} {‖ {q}_{d} ‖}^{2} )\end{matrix} ;$$

$$\{ \begin{matrix}k ( {ξ}_{f} , {ξ}_{f}^{′} ) = {c}_{f} ( {ξ}_{f} ) {\overline{k}}_{f} ( {ξ}_{f} , {ξ}_{f}^{′} ) {c}_{f} ( {ξ}_{f} ) \\ {\overline{k}}_{f} ( {ξ}_{f} , {ξ}_{f}^{′} ) = {σ}_{f}^{2} exp \{ - {( {ξ}_{f} - {ξ}_{f}^{′} )}^{T} {Λ}_{f}^{- 1} ( {ξ}_{f} - {ξ}_{f}^{′} ) \} \\ {c}_{f} ( {ξ}_{f} ) = tanh ( {α}_{f}^{2} {‖ \dot{q} ‖}^{2} )\end{matrix} ;$$

wherein, c_{H}(ξ_{H}),

$${\overline{k}}_{H} ( {ξ}_{H} , {ξ}_{H}^{′} ) ,$$

c_{C}(ξ_{C}),

$${\overline{k}}_{C} ( {ξ}_{c} , {ξ}_{C}^{′} ) ,$$

c_{f}(ξ_{f}) and

$${\overline{k}}_{f} ( {ξ}_{f} , {ξ}_{f}^{′} )$$

all represent intermediate variables, exp{·} represents an exponential function, σ_{H}, Λ_{H} and α_{H} represent hyperparameters of the kernel function corresponding to the inertial force, σ_{C}, Λ_{C} and α_{C} represent hyperparameters of the kernel function corresponding to the Coriolis force, σ_{f}, Λ_{f} and α_{f} represent hyperparameters of the kernel function corresponding to the frictional force.

In some embodiments, the step of constructing a training set based on a data optimization method includes:
obtaining the position q, the velocity \dot{q}, and an acceleration \ddot{q} of input data of the robot, and simultaneously obtain output data τ-\hat{τ} of the robot, wherein τ represents the control moment of the robot and \hat{τ} represents a nominal value of the unknown dynamic model;
using the position q as input data of the data optimization method, denoted as, Q∈N^{N×n}, wherein N is a data dimension and n is the degree of freedom of the robot, R^{N×n} represents a matrix of N rows and n columns, and transforming a data optimization process into a convex optimization problem as follows:

$${min}_{\hat{Q}} {‖ \hat{Q} - Q ‖}_{F} + {‖ {D}_{1} \hat{Q} {W}_{1} ‖}_{F} + {‖ {D}_{2} \hat{Q} {W}_{2} ‖}_{F} ;$$

wherein, ∥X∥_{F} represents a F norm of a matrix X, \hat{Q} represents a result of noise reduction processing on the input data Q, that is, a position matrix after the noise reduction processing on the input data; and D₁, W₁, D₂, W₂ are intermediate variables with definitions as follows:

$$\{ \begin{matrix}{D}_{1} = [ \begin{matrix}- {I}_{N - 1} & {0}_{( N - 1 ) \times 1}\end{matrix} ] + [ \begin{matrix}{0}_{( N - 1 ) \times 1} & {I}_{N - 1}\end{matrix} ] \\ {D}_{2} = [ \begin{matrix}- {I}_{N - 2} & {0}_{( N 2 ) \times 2}\end{matrix} ] + [ \begin{matrix}{0}_{( N - 2 ) \times 2} & {I}_{N - 2}\end{matrix} ] + [ \begin{matrix}{0}_{( N - 2 ) \times 1} & - 2 {I}_{N - 2} & {0}_{( N - 2 ) \times 1}\end{matrix} ] \\ {W}_{1} = diag \{ {ω}_{1} \} , {ω}_{1} ∈ {R}^{n} \\ {W}_{2} = diag \{ {ω}_{2} \} , {ω}_{2} ∈ {R}^{n}\end{matrix} ;$$

wherein, I_{N-1} represents a unit matrix of N−1 dimensions, I_{N-2} represents a unit matrix of N−2 dimensions, Rⁿ represents a n-dimensional vector, and ω₁,ω₂ respectively represents convex optimization parameters; the following formula is obtained through numerical calculation:

$${\hat{Q}}_{: , k} = {( {I}_{N} + {ω}_{1 , k}^{2} {D}_{1}^{T} {D}_{1} + {ω}_{2 , k}^{2} {D}_{2}^{T} {D}_{2} )}^{- 1} {Q}_{: , k} ;$$

wherein, \hat{Q}ᵢₖ represents a k-th column of the position matrix after the noise reduction processing, I_{N} represents the unit matrix of N dimensions, ω_{1,k} represents a k-column of the convex optimization parameter ω₁ ω_{2,k} represents a k-column of the convex optimization parameter ω₂ and Qᵢₖ represents a k-th column of the input data, and k∈1, . . . , n;
therefore, a velocity matrix \dot{Q}∈R^{(N-1)×n} after the noise reduction processing, and an acceleration matrix \ddot{Q}∈R^{(N-2)×n} after the noise reduction processing, and the obtained training set are respectively expressed as follows:

$$\begin{matrix}\{ \begin{matrix}\dot{Q} = \frac{1}{T} {D}_{1} \hat{Q} \\ \ddot{Q} = \frac{1}{{T}^{2}} {D}_{2} \hat{Q}\end{matrix} \\ Ξ = [ \begin{matrix}\hat{Q} & \dot{Q} & \ddot{Q}\end{matrix} ] ;\end{matrix} ;$$

wherein, R^{(N-1)×n} represents a matrix of N−1 rows and n columns, R^{(N-2)×n} represents a matrix of N−2 rows and n columns, Ξ represents the training set, T represents a sampling period.

In some embodiments, the joint impedance controller of the robot is represented as follows:

$$\{ \begin{matrix}τ = {τ}_{f b} + {τ}_{ff} \\ {τ}_{f b} = - Ke - D \dot{e} \\ {τ}_{ff} = g ( q ) + \hat{H} ( q ) {\ddot{q}}_{d} + \hat{C} ( q , \dot{q} ) {\dot{q}}_{d} + {\hat{τ}}_{f} ( \dot{q} ) + {μ}_{G P} ( {ξ}^{*} )\end{matrix} ;$$

wherein, τ represents the control moment of the robot, τ_{fb}, τ_{ff} are intermediate variables, D and K are constant matrices; e represents the position error of the robot joint, ė represents the velocity error of the robot joint, g(q) represents the gravitational moment of the robot, Ĥ(q) represents the nominal value of the inertia matrix of the robot, \ddot{q}_{d} represents the desired acceleration of the robot joint, Ĉ(q,\dot{q}) represents the nominal value of the Coriolis force and centrifugal force matrix of the robot, \dot{q}_{d} represents the desired velocity of the robot joint, \hat{τ}_{f}(\dot{q}) represents the nominal value of the friction torque of the robot, and μ_{GP}(ξ*) represents the Gaussian prediction value of the unknown dynamic model.

According to a second aspect, the present disclosure provides a robot compliance control system with parameter self-learning, including a Gaussian process construction module, an offline training module, and an online observation control module, wherein:
the Gaussian process construction module is configured to construct a joint dynamics model and a joint impedance control model for a robot, thereby obtaining an unknown dynamic model of the robot; and construct a Gaussian process with a structure consistent with the unknown dynamic model of the robot, denoted as a structure-consistent Gaussian process;
the offline training module is configured to construct a training set based on a data optimization method, and train hyperparameters of the structure-consistent Gaussian process offline using the training set; and
the online observation control module is configured to observe a robot state in real-time, predict the unknown dynamic model of the robot online through the structure-consistent Gaussian process, and output a Gaussian prediction value of the unknown dynamic model; based on the Gaussian prediction value of the unknown dynamic model, output a control moment through a robot joint impedance controller and send the control moment to the robot; determine whether the robot has reached a desired position, if yes, ending; otherwise, continuing to observe the robot state.

According to a third aspect, the present disclosure further provides a robot compliance control apparatus with parameter self-learning, including a processor and a memory storing a plurality of computer instructions, wherein, when being executed by the processor, the computer instructions implement the steps of the above robot compliance control method with parameter self-learning.

To reduce the impact on the performance caused by the uncertainty of the dynamic model during the robot operation and simultaneously consider the compliance performance of the robot, based on the Gaussian process regression, the present disclosure proposes an impedance control method, system, and apparatus based on the structure-consistent Gaussian process, in which the Gaussian process consistent with the dynamic model of the robot is designed to predict and compensate for the dynamic model of the robot online through the Gaussian process, effectively improving the comprehensive performance of the robot control system and achieving high-precision control during robot machining.

### BRIEF DESCRIPTION OF DRAWINGS

FIG. 1 is a flowchart of a robot compliance control method with parameter self-learning according to an embodiment of the present disclosure;

FIG. 2 shows prediction results of an unknown dynamic model in the experiment of the present disclosure; and

FIG. 3 shows comparisons of trajectory tracking errors in the experiment of the present disclosure.

### DESCRIPTION OF EMBODIMENTS

To make the objectives, technical solutions, and advantages of the embodiments of this application clearer, the technical solutions in the embodiments of this application will be described clearly and comprehensively below in conjunction with the accompanying drawings. Obviously, the described embodiments are only a part of the embodiments of the present disclosure, not all of them. Based on the embodiments of the present disclosure, all other embodiments obtained by those of ordinary skill in the art without creative effort fall within the scope of protection of the present disclosure.

Unless otherwise defined, all technical and scientific terms used in this document have the same meaning as commonly understood by those skilled in the technical field of the present disclosure. The terms used in the specification of the present disclosure in this document are solely for the purpose of describing specific embodiments and are not intended to limit the present disclosure.

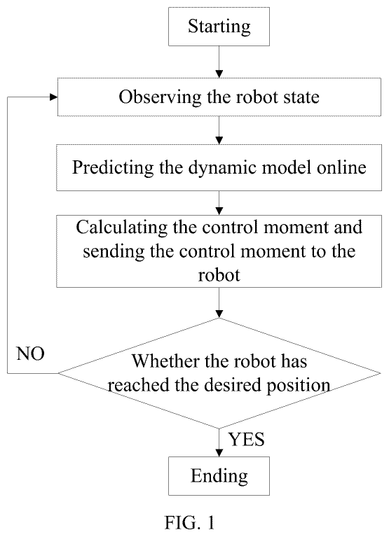

Embodiment 1: As shown in FIG. 1, a robot compliance control method with parameter self-learning is provided, which is applied to a robot control system and includes steps as follows.

Step 1, constructing a joint dynamics model and a joint impedance control model for a robot to obtain an unknown dynamic model of the robot.

The joint dynamics model for constructing the robot with n degrees of freedom is as follows:

$$H ( q ) \ddot{q} + C ( q , \dot{q} ) \dot{q} + g ( q ) + {τ}_{f} ( \dot{q} ) = τ + {τ}_{e} .$$

Wherein, q, \dot{q}, \ddot{q}∈Rⁿ respectively represent a position, a velocity, and an acceleration of a robot joint, H(q)∈R^{n×n} represents an inertia matrix of the robot, C(q,\dot{q})∈R^{n×n} represents a Coriolis force and centrifugal force matrix of the robot, g(q)∈Rⁿ represents a gravitational moment of the robot, τ_{f}(\dot{q})∈Rⁿ represents a friction torque of the robot, τ∈Rⁿ, τₑ∈Rⁿ respectively represent a control moment and a contact moment of the robot, Rⁿ represents n-dimensional vector, and R^{n×n} represents a n×n matrix.

The joint impedance control model is constructed as follows:

$$\{ \begin{matrix}\overline{H} \ddot{e} + \overline{D} \dot{e} + \overline{K} e = {τ}_{e} \\ e = q - {q}_{d}\end{matrix} .$$

Wherein, H̅, D̅, K̅ respectively represent an inertia matrix, a damping matrix, and a stiffness matrix in the joint impedance control model; e, ė,ë respectively represent a position error, a velocity error, and an acceleration error of the robot joint; and q_{d} represents a desired trajectory of the robot joint. Thus, the following formula can be obtained:

$$\ddot{q} = {\overline{H}}^{- 1} ( {τ}_{e} - \overline{K} e - \overline{D} \dot{e} ) + {\ddot{q}}_{d} .$$

Wherein, \ddot{q}_{d} represents a desired acceleration of the robot joint, thus an impedance control rate of the robot joint is obtained as:

$$\{ \begin{matrix}τ = {τ}_{fb} + {τ}_{ff} \\ {τ}_{fb} = H ( q ) \overline{H} ( {τ}_{e} - \overline{K} e - ( \overline{D} - \overline{H} {H ( q )}^{- 1} C ( q , \dot{q} ) ) \dot{e} ) \\ {τ}_{ff} = g ( q ) + {τ}_{f} ( \dot{q} ) + H ( q ) {\ddot{q}}_{d} + C ( q , \dot{q} ) {\dot{q}}_{d}\end{matrix} .$$

Wherein, τ_{fb}, τ_{ff} are intermediate variables, which respectively represent components containing an impedance parameter and the unknown dynamic model, and \dot{q}_{d} represents a desired velocity of the robot joint. To clarify the formula, (g), (q,\dot{q}), (\dot{q}) is omitted in subsequent description in this embodiment, that is, H(q)≙H,C(q,\dot{q})≙C,g(q)≙g,τ_{f}(\dot{q})≙τ_{f}. By setting:

$$\{ \begin{matrix}\overline{H} = H \\ \overline{D} = C + D \\ \overline{K} = K\end{matrix} ;$$

wherein, D and K are constant matrices, the following formula is obtained:

$${τ}_{fb} = - Ke - D \dot{e} .$$

Due to the strong coupling and nonlinear characteristics of the robot, it is difficult to accurately obtain H, C, τ_{f} in practical applications. Therefore, Ĥ,Ĉ,\hat{τ}_{f} are used to represent nominal values of H, C, τ_{f}, then τ_{ff} can be rewritten as:

$${τ}_{ff} = g + \hat{H} {\ddot{q}}_{d} + \hat{C} {\dot{q}}_{d} + {\hat{τ}}_{f} + μ ;$$

wherein, μ represents the unknown dynamic model of the robot, expressed as:

$$\{ \begin{matrix}μ = {μ}_{H} + {μ}_{C} + {μ}_{f} \\ {μ}_{H} = ( H - \hat{H} ) {\ddot{q}}_{d} \\ {μ}_{C} = ( C - \hat{C} ) {\dot{q}}_{d} \\ {μ}_{f} = {τ}_{f} - {\hat{τ}}_{f}\end{matrix} ;$$

wherein, μ_{H}, μ_{C}, μ_{f} respectively represent an inertial force component, a Coriolis force component, and a frictional force component in the unknown dynamic model of the robot. It can be seen that the unknown dynamic model of the robot satisfies the following structure:

$$\{ \begin{matrix}{μ}_{H} ( q , {0}_{n \times 1} ) = {0}_{n \times 1} \\ {μ}_{C} ( q , {0}_{n \times 1} , {\dot{q}}_{d} ) = {μ}_{C} ( q , \dot{q} , {0}_{n \times 1} ) = {0}_{n \times 1} \\ {μ}_{f} ( {0}_{n \times 1} ) = {0}_{n \times 1}\end{matrix} .$$

From the above formula, it can be seen that when the input \ddot{q}_{d}=0 is, μ_{H}=0; when \dot{q}_{d}=0 or \dot{q}=0, μ_{C}=0; when \dot{q}=0, μ_{f}=0, Based on this, the present disclosure designs a Gaussian process with a consistent structure that conforms to this structure. In the above formula, μ_{H}(q,0_{n×1}) represents the inertial force when the input is q and 0_{n×1}, μ_{C}(q,0_{n×1},\dot{q}_{d}) represents the Coriolis force when the input is q, 0_{n×}1 and \dot{q}_{d}, μ_{C}(q,0_{n×}1, \dot{q}_{d}) represents the inertial force when the input is q, \dot{q}, and 0_{n×1}: μ_{f}(0_{n×1}) represents the frictional force when the input is 0_{n×1}, and 0_{n×1} represents a zero-valued matrix of n×1 dimensions.

Step 2, constructing a Gaussian process with a structure consistent with the unknown dynamic model of the robot, denoted as a structure-consistent Gaussian process.

Since the inertial force μ_{H}, the Coriolis force μ_{C}, and the frictional force μ_{f} in the unknown dynamic model of the robot all have n dimensions, n independent Gaussian processes are designed to respectively predict each dimension of μ_{H}, μ_{C}, μ_{f}.

Three parameters are defined as:

$${ξ}_{H}^{T} = [ \begin{matrix}{q}^{T} & {\ddot{q}}_{d}^{T}\end{matrix} ] , {ξ}_{C}^{T} = [ \begin{matrix}{q}^{T} & \dot{q} & {\dot{q}}_{d}^{T}\end{matrix} ] ,$$

and, ξ_{f}=\dot{q}, and μ_{H}, μ_{C}, μ_{f} are set to follow the following Gaussian distributions respectively:

$$\{ \begin{matrix}{μ}_{H} \sim GP ( 0 , k ( {ξ}_{H} , {ξ}_{H}^{′} ) ) \\ {μ}_{C} \sim GP ( 0 , k ( {ξ}_{C} , {ξ}_{C}^{′} ) ) \\ {μ}_{f} \sim GP ( 0 , k ( {ξ}_{f} , {ξ}_{f}^{′} ) )\end{matrix} .$$

Wherein, GP(·) represents a Gaussian distribution, T represents a transpose operation of a matrix, q represents the position of the robot joint, \dot{q} represents the velocity of the robot joint, \dot{q}_{d} represents the desired velocity of the robot joint, \ddot{q}_{d} represents the desired acceleration of the robot joint, k(·) represents a variance,

$${ξ}_{H}^{′} , {ξ}_{C}^{′} and {ξ}_{f}^{′}$$

respectively represent inputs corresponding to the inertial force, the Coriolis force, and the frictional force from the training set,

$$k ( {ξ}_{H} , {ξ}_{H}^{′} )$$

represents a variance of the inertial force in the unknown dynamic model,

$$k ( {ξ}_{C} , {ξ}_{C}^{′} )$$

represents a variance of the Coriolis force in the unknown dynamic model,

$$k ( {ξ}_{f} , {ξ}_{f}^{′} )$$

represents a variance of the frictional the unknown dynamic model, force in the unknown dynamic model, and

$$k ( {ξ}_{H} , {ξ}_{H}^{′} ) , k ( {ξ}_{C} , {ξ}_{C}^{′} ) , and k ( {ξ}_{f} , {ξ}_{f}^{′} )$$

are expressed as:

$$\{ \begin{matrix}k ( {ξ}_{H} , {ξ}_{H}^{′} ) = E [ μ ( {ξ}_{H} ) μ ( {ξ}_{H}^{′} ) ] \\ k ( {ξ}_{C} , {ξ}_{C}^{′} ) = E [ μ ( {ξ}_{C} ) μ ( {ξ}_{C}^{′} ) ] \\ k ( {ξ}_{f} , {ξ}_{f}^{′} ) = E [ μ ( {ξ}_{f} ) μ ( {ξ}_{f}^{′} ) ]\end{matrix}$$

wherein, E[·] represents a desired value, μ(·) represents a mean, μ(ξ_{H}) represents the variance when the input is ξ_{H} and so on. Similarly,

$$E [ μ ( {ξ}_{H} ) μ ( {ξ}_{H}^{′} ) ]$$

represents the desired value when the input is

$$μ ( {ξ}_{H} ) μ ( {ξ}_{H}^{′} )$$

and so on.

$$k ( {ξ}_{H} , {ξ}_{H}^{′} )$$

represents the variance when the input is ξ, ξ′ and so on.

The inertial force μ_{H}, the Coriolis force μ_{C}, and the frictional force μ_{f} are set to be mutually independent, that is, a covariance of the inertial force μ_{H}, a covariance of the Coriolis force μ_{C}, and a covariance of the frictional force μ_{f} are set to be all 0:

$$\{ \begin{matrix}Cov ( μ ( {ξ}_{H} ) , μ ( {ξ}_{C} ) ) = E [ μ ( {ξ}_{H} ) μ ( {ξ}_{C}^{′} ) ] = 0 \\ Cov ( μ ( {ξ}_{H} ) , μ ( {ξ}_{f} ) ) = E [ μ ( {ξ}_{H} ) μ ( {ξ}_{f}^{′} ) ] = 0 \\ Cov ( μ ( {ξ}_{C} ) , μ ( {ξ}_{f} ) ) = E [ μ ( {ξ}_{C} ) μ ( {ξ}_{f}^{′} ) ] = 0\end{matrix} ;$$

wherein, Cov(·) represents the covariance, Cov(μ(ξ_{H}), μ(ξ_{C})) represents the covariance when the input is μ(ξ_{H}), μ(ξ_{C}), and so on. The variance function of the compensation term U is:

$$k ( ξ , {ξ}^{′} ) = E [ μ ( ξ ) μ ( {ξ}^{′} ) ] = k ( {ξ}_{H} , {ξ}_{H}^{′} ) + k ( {ξ}_{C} , {ξ}_{C}^{′} ) + k ( {ξ}_{f} , {ξ}_{f}^{′} ) ;$$

wherein, ξ and ξ′ respectively represent an actual input value and an input of the unknown dynamic model from the training set.

Similarly, Cov(μ(ξ_{H}), μ(ξ′)), Cov(μ(ξ_{C}), μ(ξ′), Cov(μ(ξ_{f}), μ(ξ′)) are respectively:

$$\{ \begin{matrix}Cov ( μ ( {ξ}_{H} ) , μ ( {ξ}^{′} ) ) = k ( {ξ}_{H} , {ξ}_{H}^{′} ) \\ Cov ( μ ( {ξ}_{C} ) , μ ( {ξ}^{′} ) ) = k ( {ξ}_{C} , {ξ}_{C}^{′} ) \\ Cov ( μ ( {ξ}_{f} ) , μ ( {ξ}^{′} ) ) = k ( {ξ}_{f} , {ξ}_{f}^{′} )\end{matrix} .$$

Therefore, for the priori ξ*, a joint probability distribution is obtained as follows:

$$p ( [ \begin{matrix}μ ( {ξ}_{H}^{°} ) \\ μ ( {ξ}_{C}^{°} ) \\ μ ( {ξ}_{f}^{°} ) \\ y\end{matrix} ] \vert [ \begin{matrix}ξ° \\ Ξ\end{matrix} ] ) = ℕ ( [ \begin{matrix}0 \\ 0 \\ 0 \\ {0}_{N \times 1}\end{matrix} ] , [ \begin{matrix}{k}_{H}^{°} & 0 & 0 & {\vec{k}}_{H} ( {ξ}_{H}^{°} ) \\ 0 & {k}_{C}^{°} & 0 & {\vec{k}}_{C} ( {ξ}_{C}^{°} ) \\ 0 & 0 & {k}_{f}^{°} & {\vec{k}}_{f} ( {ξ}_{f}^{°} ) \\ {\vec{k}}_{H} ( {ξ}_{H}^{°} ) & {\vec{k}}_{C} ( {ξ}_{C}^{°} ) & {\vec{k}}_{f} ( {ξ}_{f}^{°} ) & K + {σ}^{2} I\end{matrix} ] ) ;$$

wherein, p(·) represents a probability,

$${ξ}_{H}^{*}$$

represents a priori of the inertial force of the unknown dynamic model,

$${ξ}_{C}^{*}$$

represents a priori of the Coriolis force of the unknown dynamic model,

$${ξ}_{f}^{*}$$

represents a priori of the frictional force

$$μ ( {ξ}_{H}^{*} )$$

is a mean of the priori of the inertial force,

$${ξ}_{H}^{*}$$

represents a mean of the priori of the Coriolis force,

$$μ ( {ξ}_{C}^{*} )$$

represents a mean of the priori of the frictional force,

$${ξ}_{C}^{*}$$

represents the training set, y represents an output, [symbol] (·) represents the Gaussian distribution, N represents a length of position data of the robot,

$${k}_{H}^{*} , {k}_{C}^{*} and {k}_{f}^{*}$$

respectively represent priori kernel function values corresponding to the inertial force, the Coriolis force, and the frictional force,

$${\vec{k}}_{H} ( {ξ}_{H}^{*} ) , {\vec{k}}_{C} ( {ξ}_{C}^{*} ) and {\vec{k}}_{f} ( {ξ}_{f}^{*} )$$

respectively represent kernel function vectors corresponding to the inertial force, the Coriolis force, and the frictional force, K represents a kernel function matrix, σ represents a noise variance, I represents an identity matrix,

$${k}_{H}^{*} {=}^{Δ} k ( {ξ}_{H}^{*} , {ξ}_{H}^{*} ) , {{\vec{k}}_{H} ( {ξ}_{H}^{*} )}_{i} = k ( {ξ}_{H}^{*} , {ξ}_{i} ) ,$$

ξᵢ represents the i-th data in the training set,

$${{\vec{k}}_{H} ( {ξ}_{H}^{*} )}_{i}$$

represents the kernel function value corresponding to ξᵢ, and Ξ represents the training set. Thus, the following formula can be obtained:

$$p ( [ \begin{matrix}μ ( {ξ}_{H}^{*} ) \\ μ ( {ξ}_{C}^{*} ) \\ μ ( {ξ}_{f}^{*} )\end{matrix} ] \vert {ξ}^{*} , y , Ξ ) = ℕ ( [ \begin{matrix}{μ}_{H , GP} ( {ξ}_{H}^{*} ) \\ {μ}_{C , GP} ( {ξ}_{C}^{*} ) \\ {μ}_{f , GP} ( {ξ}_{f}^{*} )\end{matrix} ] , {σ}_{GP , HCf}^{2} ( {ξ}^{*} ) ) ;$$

wherein,

$${μ}_{H , GP} ( {ξ}_{H}^{*} )$$

represents a Gaussian prediction value of the inertial force in the unknown dynamic model,

$${μ}_{C , GP} ( {ξ}_{C}^{*} )$$

represents a Gaussian prediction value of the Coriolis force in the unknown dynamic model,

$${μ}_{f , GP} ( {ξ}_{f}^{*} )$$

represents a Gaussian prediction value of the frictional force in the unknown dynamic model,

$${σ}_{GP , HCf}^{2} ( {ξ}^{*} )$$

represents the joint variance, wherein:

$$\{ \begin{matrix}{μ}_{H , GP} ( {ξ}_{H}^{*} ) = {{\vec{k}}_{H} ( {ξ}_{H}^{*} )}^{T} {( K + {σ}^{2} I )}^{- 1} y \\ {μ}_{C , GP} ( {ξ}_{C}^{*} ) = {{\vec{k}}_{C} ( {ξ}_{C}^{*} )}^{T} {( K + {σ}^{2} I )}^{- 1} y \\ {μ}_{f , GP} ( {ξ}_{f}^{*} ) = {{\vec{k}}_{f} ( {ξ}_{f}^{*} )}^{T} {( K + {σ}^{2} I )}^{- 1} y\end{matrix} .$$

Therefore, for the unknown dynamic model μ, a Gaussian process prediction is:

$${μ}_{GP} ( {ξ}^{*} ) = {μ}_{H , GP} ( {ξ}_{H}^{*} ) + {μ}_{C , GP} ( {ξ}_{C}^{*} ) + {μ}_{f , GP} ( {ξ}_{f}^{*} ) = {\vec{k} ( {ξ}^{*} )}^{T} {( K + {σ}^{2} I )}^{- 1} y ;$$

wherein, μ_{GP}(ξ*) represents a Gaussian prediction value of the unknown dynamic model, and \vec{k}(ξ*) represents a Gaussian prediction variance of the unknown dynamic model.

To maintain the structural consistency between the Gaussian process and the unknown dynamic model of the robot, corresponding kernel functions

$$k ( {ξ}_{H} , {ξ}_{H}^{′} ) , k ( {ξ}_{C} , {ξ}_{C}^{′} ) , k ( {ξ}_{f} , {ξ}_{f}^{′} )$$

are respectively designed for the inertial force μ_{H}, the Coriolis force μ_{C}, and the frictional force μ_{f} to satisfy the structure of the unknown dynamic model as follows:

$$\{ \begin{matrix}k ( {ξ}_{H} , {ξ}_{H}^{′} ) = {c}_{H} ( {ξ}_{H} ) {\overline{k}}_{H} ( {ξ}_{H} , {ξ}_{H}^{′} ) {c}_{H} ( {ξ}_{H} ) \\ {\overline{k}}_{H} ( {ξ}_{H} , {ξ}_{H}^{′} ) = {σ}_{H}^{2} exp \{ - {( {ξ}_{H} - {ξ}_{H}^{′} )}^{T} {Λ}_{H}^{- 1} ( {ξ}_{H} - {ξ}_{H}^{′} ) \} \\ {c}_{H} ( {ξ}_{H} ) = tanh ( {α}_{H}^{2} {‖ {\ddot{q}}_{d} ‖}^{2} )\end{matrix} ;$$

$$\{ \begin{matrix}k ( {ξ}_{C} , {ξ}_{C}^{′} ) = {c}_{C} ( {ξ}_{C} ) {\overline{k}}_{C} ( {ξ}_{C} , {ξ}_{C}^{′} ) {c}_{C} ( {ξ}_{C} ) \\ {\overline{k}}_{C} ( {ξ}_{C} , {ξ}_{C}^{′} ) = {σ}_{C}^{2} exp \{ - {( {ξ}_{C} - {ξ}_{C}^{′} )}^{T} {Λ}_{C}^{- 1} ( {ξ}_{C} - {ξ}_{C}^{′} ) \} \\ {c}_{C} ( {ξ}_{C} ) = tanh ( {α}_{C}^{2} {‖ \dot{q} ‖}^{2} {‖ {\dot{q}}_{d} ‖}^{2} )\end{matrix} ;$$

$$\{ \begin{matrix}k ( {ξ}_{f} , {ξ}_{f}^{′} ) = {c}_{f} ( {ξ}_{f} ) {\overline{k}}_{f} ( {ξ}_{f} , {ξ}_{f}^{′} ) {c}_{f} ( {ξ}_{f} ) \\ {\overline{k}}_{f} ( {ξ}_{f} , {ξ}_{f}^{′} ) = {σ}_{f}^{2} exp \{ - {( {ξ}_{f} - {ξ}_{f}^{′} )}^{T} {Λ}_{f}^{- 1} ( {ξ}_{f} - {ξ}_{f}^{′} ) \} \\ {c}_{f} ( {ξ}_{f} ) = tanh ( {α}_{f}^{2} {‖ \dot{q} ‖}^{2} )\end{matrix} .$$

Wherein, c_{H}(ξ_{H}),

$${\overline{k}}_{H} ( {ξ}_{H} , {ξ}_{H}^{′} ) ,$$

c_{C}(ξ_{C}),

$${\overline{k}}_{C} ( {ξ}_{C} , {ξ}_{C}^{′} ) ,$$

c_{f}(ξ_{f}) and

$${\overline{k}}_{f} ( {ξ}_{f} , {ξ}_{f}^{′} )$$

all represent intermediate variables, exp{·} represents an exponential function, σ_{H}, Λ_{H} and α_{H} represent hyperparameters of the kernel function corresponding to the inertial force, σ_{C}, Λ_{C} and α_{C} represent hyperparameters of the kernel function corresponding to the Coriolis force, σ_{f}, Λ_{f} and α_{f} represent hyperparameters of the kernel function corresponding to the frictional force.

Step 3, constructing a training set based on a data optimization method, and training hyperparameters of the structure-consistent Gaussian process offline using the training set.

Before utilizing the structure-consistent Gaussian process for impedance control, it is necessary to collect relevant data and construct the training set. The training results of the hyperparameters directly affect the accuracy of the unknown dynamic model of the robot, and the training set is fundamental to the training of the hyperparameters. Therefore, it is necessary to reduce the noise of the constructed training set to improve the training effect of the hyperparameters. In this embodiment, a convex optimization method is used as the data optimization method. Based on the convex optimization method, noise reduction processing is performed on the position q, the velocity \dot{q}, and the acceleration \ddot{q} obtained by sensors, and the training set is constructed as follows.

Based on the joint dynamics model of the robot, the position q, the velocity \dot{q}, and the acceleration \ddot{q} of input data of the robot are obtained, while output data τ-\hat{τ} of the robot representing the control moment of the robot and the nominal value of the unknown dynamic model are also obtained. Wherein:

$$\hat{τ} = \hat{H} \ddot{q} + C \dot{q} + g + {\hat{τ}}_{f} + {τ}_{e} .$$

Therefore, for μ_{H}, μ_{C}, μ_{f}, the input items are respectively (q,\ddot{q}) (q,\dot{q},\dot{q}) and \dot{q}. In practical applications, the sensor can only obtain the position q, the velocity

$${\dot{q}}_{i} = \frac{{q}_{i + 1} - {q}_{i}}{T} ,$$

and the acceleration

$${\ddot{q}}_{i} = \frac{{\dot{q}}_{i + 1} - {\dot{q}}_{i}}{T} ,$$

wherein T is a sampling period. Due to the small sampling period I, this embodiment defines T=1 ms, which amplifies the influence of noise during the calculation of \dot{q},\ddot{q} Therefore, when the training set is constructed, it is necessary to perform the noise reduction processing on the original data. \dot{q}ᵢ represents a 1-th velocity data point, qᵢ represents a i-th position data qᵢ₊₁ represents a (i+1)-th position data point, point, and \dot{q}ᵢ₊₁ represents a (i+1)-th velocity data point.

Therefore, the position q is taken as the input data for the convex optimization method, denoted as Q∈R^{N×n}, wherein N is the dimension of the data and n is the degree of freedom of the robot. R^{N×n} represents a matrix of N rows and n columns. The data noise reduction process is transformed into a convex optimization problem, as follows:

$${min}_{\hat{Q}} {‖ \hat{Q} - Q ‖}_{F} + {‖ {D}_{1} \hat{Q} {W}_{1} ‖}_{F} + {‖ {D}_{2} \hat{Q} {W}_{2} ‖}_{F} .$$

Wherein, ∥X∥^{F} represents a F norm of a matrix X, \hat{Q}, represents the result of the noise reduction processing on the input data Q, that is, the position matrix after the noise reduction processing. D₁, W₁, D₂, W₂ are intermediate variables with definitions as follows:

$$\{ \begin{matrix}{D}_{1} = [ \begin{matrix}- {I}_{N - 1} & {0}_{( N - 1 ) \times 1}\end{matrix} ] + [ \begin{matrix}{0}_{( N - 1 ) \times 1} & {I}_{N - 1}\end{matrix} ] \\ {D}_{2} = [ \begin{matrix}- {I}_{N - 2} & {0}_{( N - 2 ) \times 2}\end{matrix} ] + [ \begin{matrix}{0}_{( N - 2 ) \times 2} & {I}_{N - 2}\end{matrix} ] + \\ [ \begin{matrix}{0}_{( N - 2 ) \times 1} & - 2 {I}_{N - 2} & {0}_{( N - 2 ) \times 1}\end{matrix} ] \\ {W}_{1} = diag \{ {ω}_{1} \} , {ω}_{1} ∈ {R}^{n} \\ {W}_{2} = diag \{ {ω}_{2} \} , {ω}_{2} ∈ {R}^{n}\end{matrix} ;$$

wherein, I_{N-1} represents a unit matrix of N−1 dimensions, I_{N-2} represents a unit matrix of N−2 dimensions, Rⁿ represents a n-dimensional vector, and ω₁, ω₂ respectively represent convex optimization parameters. Through numerical calculation, the following formula can be obtained:

$${\hat{Q}}_{: , k} = {( {I}_{N} + {ω}_{1 , k}^{2} {D}_{1}^{T} {D}_{1} + {ω}_{2 , k}^{2} {D}_{2}^{T} {D}_{2} )}^{- 1} {Q}_{: , k} ;$$

wherein, \hat{Q}ᵢₖ represents a k-th column of the position matrix after the noise reduction processing, k represents the unit matrix of N dimensions, ω_{1,k} represents a k-column of the convex optimization parameter ω₁ ω_{2,k} represents a k-column of the convex optimization parameter ω₂, and Qᵢₖ represents a k-th column of the input data, and k∈1, . . . , n.

Thus, the velocity matrix \dot{Q}∈R^{(N-1)×n} after the noise reduction processing, the acceleration matrix \ddot{Q}∈R^{(N-2)×n} after the noise reduction processing, and the obtained training set are represented as follows:

$$\{ \begin{matrix}\dot{Q} = \frac{1}{T} {D}_{1} \hat{Q} \\ \ddot{Q} = \frac{1}{{T}^{2}} {D}_{2} \hat{Q}\end{matrix} ;$$

$$Ξ = [ \begin{matrix}\hat{Q} & \dot{Q} & \ddot{Q}\end{matrix} ] ;$$

wherein, R^{(N-1)×n} represents a matrix of N−1 rows and n columns, R^{(N-2)×n} represents a matrix of N−2 rows and n columns, Ξ represents the training set, T represents the sampling period. Therefore, the selection of the hyperparameters for the Gaussian process can be obtained through maximum likelihood estimation of the training set.

Step 4, observing a robot state in real-time, predicting the unknown dynamic model of the robot online using the structure-consistent Gaussian process, and outputting a Gaussian prediction value μ_{GP}(ξ*) of the unknown dynamic model.

Step 5, based on the Gaussian prediction value of the unknown dynamic model, outputting the control moment through a joint impedance controller of the robot and sending the control moment to the robot, wherein the joint impedance controller of the robot is represented as follows:

$$\{ \begin{matrix}τ = {τ}_{fb} + {τ}_{ff} \\ {τ}_{fb} = - Ke - D \dot{e} \\ {τ}_{ff} = g ( q ) + \hat{H} ( q ) {\ddot{q}}_{d} + \hat{C} ( q , \dot{q} ) {\dot{q}}_{d} + {\hat{τ}}_{f} ( \dot{q} ) + {μ}_{GP} ( {ξ}^{*} )\end{matrix} ;$$

wherein, τ represents the control moment of the robot, τ_{fb}, τ_{ff} are intermediate variables, D and K are the constant matrices. e represents the position error of the robot joint, ė represents the velocity error of the robot joint, g(q) represents the gravitational moment of the robot, Ĥ(q) represents a nominal value of the inertia matrix of the robot, \ddot{q}_{d} represents the desired acceleration of the robot joint, Ĉ(q,\dot{q}) represents a nominal value of the Coriolis force and centrifugal force matrix of the robot, \dot{q}_{d} represents the desired velocity of the robot joint, \hat{τ}_{f}(\dot{q}) represents a nominal value of the friction torque of the robot, and μ_{GP}(ξ*) represents the Gaussian prediction value of the unknown dynamic model.

Step 6, determining whether the robot has reached the desired position; if yes, ending; otherwise, continuing to observe the robot state and returning to Step 4.

The present disclosure achieves high-precision robot control by designing the Gaussian process that is consistent with the structure of the dynamic model μ of the robot, which can predict the dynamic model of the robot online and compensate the control moment τ controlled by the robot joint impedance.

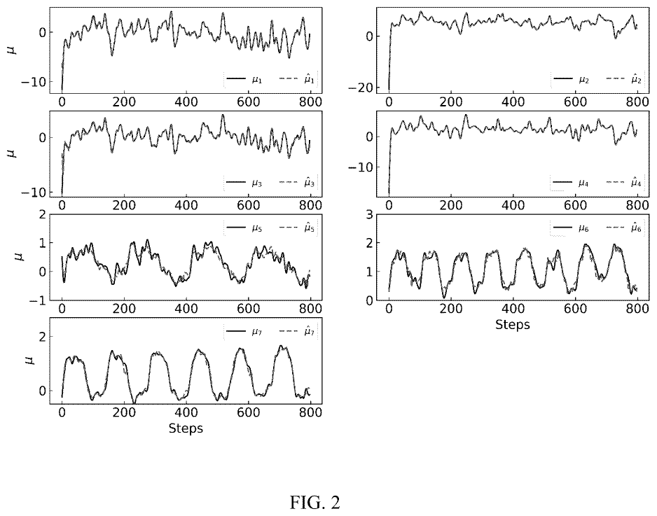

In the experiment, the training set is constructed based on a massage robot platform to verify the effectiveness of the method provided in the present disclosure in predicting the unknown dynamic model of the robot. The robot has 7 degrees of freedom. The prediction results of the unknown dynamic model are shown in FIG. 2. The ordinate μ represents the unknown dynamic model of the robot, and the abscissa “steps” represents the iteration steps, μⱼ is an actual value of the unknown dynamic model of a j-th joint of the robot, \hat{μ}ⱼ is the Gaussian prediction value of the unknown dynamic model of the j-th joint of the robot output by the structure-consistent Gaussian process, j=1, . . . , 7 represents each joint of the robot. It can be seen that the fluctuation of the prediction value closely follows the actual value, indicating that the method provided in the present disclosure is effective in predicting the unknown dynamic model of the robot.

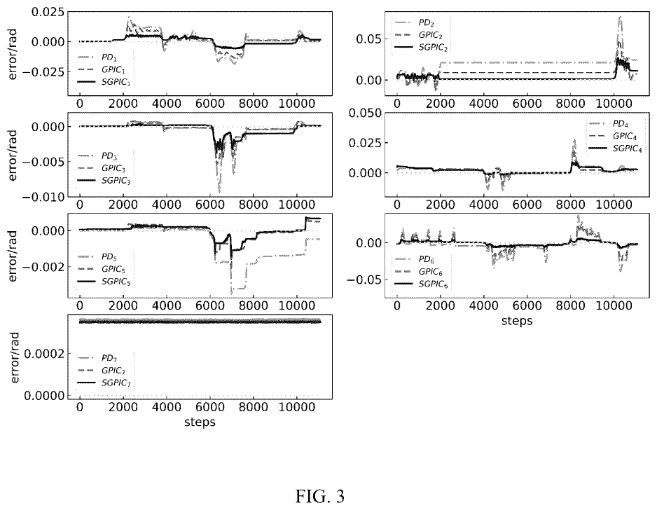

To verify the effectiveness and superiority of the method provided in the present disclosure, a comparison is conducted between the robot impedance control method based on uncompensated dynamic model and the robot impedance control method based on the Gaussian process on the massage robot platform. A trajectory tracking error comparison is shown in FIG. 3. The ordinate “error” represents the trajectory tracking error, with the unit of radian (rad), and the abscissa “steps” represents the iteration steps. PD represents the robot impedance control method based on the uncompensated unknown dynamic model, GPIC represents the conventional robot impedance control method based on the Gaussian process, SGPIC represents the impedance control method provided in the present disclosure, PDⱼ represents the trajectory tracking error of the j-th joint when the PD method is implemented, GPICⱼ represents the trajectory tracking error of the j-th joint when the GPIC method is implemented, SGPICⱼ represents the trajectory tracking error of the J-th joint when the SGPIC method is implemented, and the subscript i=1, . . . , 7 represents each joint of the robot. It can be seen that the present disclosure effectively reduces the trajectory tracking error of each joint, achieving high-precision robot control.

Embodiment 2: This embodiment provides a robot compliance control system with parameter self-learning, which includes a Gaussian process construction module, an offline training module, and an online observation control module.

The Gaussian process construction module is configured to construct a joint dynamics model and a joint impedance control model for a robot, thereby obtaining an unknown dynamic model of the robot; construct a Gaussian process with a structure consistent with the unknown dynamic model of the robot, denoted as a structure-consistent Gaussian process.

The offline training module is configured to construct a training set based on a data optimization method, and train hyperparameters of the structure-consistent Gaussian process offline using the training set.

The online observation control module is configured to observe ta robot state in real-time, predict the unknown dynamic model of the robot online through the structure-consistent Gaussian process, and output a Gaussian prediction value of the unknown dynamic model; based on the Gaussian prediction value of the unknown dynamic model, output a control moment through a robot joint impedance controller of the robot and send the control moment to the robot; determine whether the robot has reached the desired position, if yes, ending, otherwise, continuing to observe the robot state.

For specific details on the robotic compliance control system with parameter self-learning, please refer to the previous description of the robotic compliance control method with parameter self-learning, which is not repeated hereinafter.

Embodiment 3: This embodiment provides a robot compliance control apparatus with parameter self-learning, including a processor and a memory storing a plurality of computer instructions. When being executed by the processor, the computer instructions implement the steps of a robot compliance control method with parameter self-learning.

For specific details on the robot compliant control apparatus with parameter self-learning, please refer to the description of the robot compliant control method with parameter self-learning mentioned above, which is not repeated hereinafter.

The memory and the processor are electrically connected directly or indirectly to achieve data transmission or interaction of data. For example, these components can be electrically connected to each other through one or more communication buses or signal lines. The memory stores computer programs that can be run on the processor, and the processor executes the computer programs stored in the memory to implement the above method of the present disclosure.

The memory can be, but is not limited to, a random access memory (RAM), a read only memory (ROM), a programmable read-only memory (PROM), an erasable programmable read-only memory (EPROM), an electrically erasable programmable read-only memory (EEPROM), etc. The memory is configured to store at least one program, and the processor executes the program after receiving execution instructions.

The processor may be an integrated circuit chip having a data processing capability. The above processor can be a general-purpose processor, including a central processing unit (CPU), a network processor (NP), and the like. Various methods, steps, and logic block diagrams disclosed in the embodiments of the present disclosure may be implemented or performed. A general purpose processor may be a microprocessor or the processor may be any conventional processor or the like. an be a microprocessor, or it can be any conventional processor, among others.

The technical features of the embodiments described above can be arbitrarily combined. For brevity, not all possible combinations of the technical features in the aforementioned embodiments are described. However, as long as the combinations of these technical features do not contradict, they should be considered within the scope of this specification.

1. A robot compliance control method with parameter self-learning, comprising steps of:
constructing a joint dynamics model and a joint impedance control model for a robot, and obtaining an unknown dynamic model of the robot;
constructing a Gaussian process with a structure consistent with the unknown dynamic model of the robot, denoted as a structure-consistent Gaussian process;
constructing a training set based on a data optimization method, and training hyperparameters of the structure-consistent Gaussian process offline using the training set;
observing a robot state in real-time, predicting the unknown dynamic model of the robot online through the structure-consistent Gaussian process, and outputting a Gaussian prediction value of the unknown dynamic model;
based on the Gaussian prediction value of the unknown dynamic model, outputting a control moment through a joint impedance controller of the robot and sending the control moment to the robot;
determining whether the robot has reached a desired position, if yes, ending; otherwise, continuing to observe the robot state;
wherein the structure-consistent Gaussian process is constructed as follows:
since an inertial force μ_{H}, a Coriolis force μ_{C}, and a frictional force μ_{f} in the unknown dynamic model of the robot all have n dimensions, n independent Gaussian processes are designed to respectively predict each dimension of μ_{H}, μ_{C}, μ_{f};
three parameters are respectively defined as:
$${ξ}_{H}^{T} = [ \begin{matrix}{q}^{T} & {\ddot{q}}_{d}^{T}\end{matrix} ] , {ξ}_{C}^{T} = [ \begin{matrix}{q}^{T} & \dot{q} & {\dot{q}}_{d}^{T}\end{matrix} ] ,$$
and ξ_{f}=\dot{q}, and μ_{H}, μ_{C}, μ_{f} are set to follow the following Gaussian distributions respectively:
$$\{ \begin{matrix}{μ}_{H} ∼ GP ( 0 , k ( {ξ}_{H} , {ξ}_{H}^{′} ) ) \\ {μ}_{C} ∼ GP ( 0 , k ( {ξ}_{C} , {ξ}_{C}^{′} ) ) \\ {μ}_{f} ∼ GP ( 0 , k ( {ξ}_{f} , {ξ}_{f}^{′} ) )\end{matrix} ;$$
wherein, GP(·) represents a Gaussian distribution, T represents a transpose operation of a matrix, q represents a position of a robot joint, \dot{q} represents a velocity of the robot joint, \dot{q}_{d} represents a desired velocity of the robot joint, \ddot{q}_{d} represents a desired acceleration of the robot joint, k(·) represents a variance,
$${ξ}_{H}^{′} , {ξ}_{C}^{′} , and {ξ}_{f}^{′}$$
respectively represent inputs corresponding to the inertial force, the Coriolis force, and the frictional force from the training set,
$$k ( {ξ}_{H} , {ξ}_{H}^{′} )$$
represents a variance of the inertial force in the unknown dynamic model,
$$k ( {ξ}_{C} , {ξ}_{C}^{′} )$$
represents a variance of the Coriolis force in the unknown dynamic model,
$$k ( {ξ}_{f} , {ξ}_{f}^{′} )$$
represents a variance of the frictional force in the unknown dynamic model, and
$$k ( {ξ}_{H} , {ξ}_{H}^{′} ) , k ( {ξ}_{C} , {ξ}_{C}^{′} ) , and k ( {ξ}_{f} , {ξ}_{f}^{′} )$$
are expressed as:
$$\{ \begin{matrix}k ( {ξ}_{H} , {ξ}_{H}^{′} ) = E [ μ ( {ξ}_{H} ) μ ( {ξ}_{H}^{′} ) ] \\ k ( {ξ}_{C} , {ξ}_{C}^{′} ) = E [ μ ( {ξ}_{C} ) μ ( {ξ}_{C}^{′} ) ] \\ k ( {ξ}_{f} , {ξ}_{f}^{′} ) = E [ μ ( {ξ}_{f} ) μ ( {ξ}_{f}^{′} ) ]\end{matrix} ;$$
wherein, E[·] represents a desired value, and μ(·) represents a mean;
the inertial force μ_{H}, the Coriolis force μ_{C}, and the frictional force μ_{f} are set to be mutually independent, that is, a covariance of the inertial force μ_{H}, a covariance of the Coriolis force μ_{C}, and a covariance of the frictional force μ_{f} are set to be all 0:
$$\{ \begin{matrix}Cov ( μ ( {ξ}_{H} ) , μ ( {ξ}_{C} ) ) = E [ μ ( {ξ}_{H} ) μ ( {ξ}_{C}^{′} ) ] = 0 \\ Cov ( μ ( {ξ}_{H} ) , μ ( {ξ}_{f} ) ) = E [ μ ( {ξ}_{H} ) μ ( {ξ}_{f}^{′} ) ] = 0 \\ Cov ( μ ( {ξ}_{C} ) , μ ( {ξ}_{f} ) ) = E [ μ ( {ξ}_{C} ) μ ( {ξ}_{f}^{′} ) ] = 0\end{matrix} ;$$
wherein, Cov(·) represents the covariance, then a variance function of a compensation term μ is:
$$k ( ξ , {ξ}^{′} ) = E [ μ ( ξ ) μ ( {ξ}^{′} ) ] = k ( {ξ}_{H} , {ξ}_{H}^{′} ) + k ( {ξ}_{C} , {ξ}_{C}^{′} ) + k ( {ξ}_{f} , {ξ}_{f}^{′} ) ;$$
wherein, ξ and ξ′ respectively represent an actual input value and an input of the unknown dynamic model from the training set;
similarly, Cov(μ(ξ_{H}), μ(ξ′)), Cov(μ(ξ_{C}), μ(ξ′)), Cov(μ(ξ_{f}), μ(ξ′)) are respectively:
$$\{ \begin{matrix}Cov ( μ ( {ξ}_{H} ) , μ ( {ξ}^{′} ) ) = k ( {ξ}_{H} , {ξ}_{H}^{′} ) \\ Cov ( μ ( {ξ}_{C} ) , μ ( {ξ}^{′} ) ) = k ( {ξ}_{C} , {ξ}_{C}^{′} ) \\ Cov ( μ ( {ξ}_{f} ) , μ ( {ξ}^{′} ) ) = k ( {ξ}_{f} , {ξ}_{f}^{′} )\end{matrix} ;$$
therefore, for a priori ξ*, a joint probability distribution is obtained as follows:
$$p ( [ \begin{matrix}μ ( {ξ}_{H}^{*} ) \\ μ ( {ξ}_{C}^{*} ) \\ μ ( {ξ}_{f}^{*} ) \\ y\end{matrix} ] \vert [ \begin{matrix}{ξ}^{*} \\ Ξ\end{matrix} ] ) = ℕ ( [ \begin{matrix}0 \\ 0 \\ 0 \\ {0}_{N \times 1}\end{matrix} ] , [ \begin{matrix}{k}_{H}^{*} & 0 & 0 & {\vec{k}}_{H} ( {ξ}_{H}^{*} ) \\ 0 & {k}_{C}^{*} & 0 & {\vec{k}}_{C} ( {ξ}_{C}^{*} ) \\ 0 & 0 & {k}_{f}^{*} & {\vec{k}}_{f} ( {ξ}_{f}^{*} ) \\ {\vec{k}}_{H} ( {ξ}_{H}^{*} ) & {\vec{k}}_{C} ( {ξ}_{C}^{*} ) & {\vec{k}}_{f} ( {ξ}_{f}^{*} ) & K + {σ}^{2} I\end{matrix} ] ) ;$$
wherein, p(·) represents a probability,
$${ξ}_{H}^{*}$$
represents a priori of the inertial force of the unknown dynamic model,
$${ξ}_{C}^{*}$$
represents a priori of the Coriolis force of the unknown dynamic model,
$${ξ}_{f}^{*}$$
represents a priori of the frictional force of the unknown dynamic model,
$$μ ( {ξ}_{H}^{*} )$$
is a mean of the priori of the inertial force,
$${ξ}_{H}^{*}$$
represents a mean of the priori of the Coriolis force,
$$μ ( {ξ}_{C}^{*} )$$
represents a mean of the priori of the frictional force, Ξ represents the training set, y represents an output, [symbol] (·) represents the Gaussian distribution, N represents a length of position data of the robot,
$${k}_{H}^{*} , {k}_{f}^{*} and {k}_{C}^{*}$$
respectively represent priori kernel function values corresponding to the inertial force, the Coriolis force, and the frictional force;
$${\vec{k}}_{H} ( {ξ}_{H}^{*} ) , {\vec{k}}_{C} ( {ξ}_{C}^{*} ) , and {\vec{k}}_{f} ( {ξ}_{f}^{*} )$$
respectively represent kernel function vectors corresponding to the inertial force, the Coriolis force, and the frictional force, K represents a kernel function matrix, σ represents a noise variance, I represents an identity matrix,
$${k}_{H}^{*} {=}^{Δ} k ( {ξ}_{H}^{*} , {ξ}_{H}^{*} ) , {{\vec{k}}_{H} ( {ξ}_{H}^{*} )}_{i} = k ( {ξ}_{H}^{*} , {ξ}_{i} ) ,$$
ξᵢ represents i-th data in the training set,
$${{\vec{k}}_{H} ( {ξ}_{H}^{*} )}_{i}$$
represents the kernel function value corresponding to ξᵢ, and Ξ represents the training set, thus:
$$p ( [ \begin{matrix}μ ( {ξ}_{H}^{*} ) \\ μ ( {ξ}_{C}^{*} ) \\ μ ( {ξ}_{f}^{*} )\end{matrix} ] {ξ}^{*} , y , Ξ ) = ℕ ( [ \begin{matrix}{μ}_{H , GP} ( {ξ}_{H}^{*} ) \\ {μ}_{C , GP} ( {ξ}_{C}^{*} ) \\ {μ}_{f , GP} ( {ξ}_{f}^{*} )\end{matrix} ] , {σ}_{GP , HCf}^{2} ( {ξ}^{*} ) ) ;$$
wherein,
$${μ}_{H , GP} ( {ξ}_{H}^{*} )$$
represents a Gaussian prediction value of the inertial force in the unknown dynamic model,
$${μ}_{C , GP} ( {ξ}_{C}^{*} )$$
represents a Gaussian prediction value of the Coriolis force in the unknown dynamic model,
$${μ}_{f , GP} ( {ξ}_{f}^{*} )$$
represents a Gaussian prediction value of the frictional force in the unknown dynamic model,
$${σ}_{GP , HCf}^{2} ( {ξ}^{*} )$$
represents the joint variance, wherein:
$$\{ \begin{matrix}{μ}_{H , GP} ( {ξ}_{H}^{*} ) = {{\vec{k}}_{H} ( {ξ}_{H}^{*} )}^{T} {( K + {σ}^{2} I )}^{- 1} y \\ {μ}_{C , GP} ( {ξ}_{C}^{*} ) = {{\vec{k}}_{C} ( {ξ}_{C}^{*} )}^{T} {( K + {σ}^{2} I )}^{- 1} y \\ {μ}_{f , GP} ( {ξ}_{f}^{*} ) = {{\vec{k}}_{f} ( {ξ}_{f}^{*} )}^{T} {( K + {σ}^{2} I )}^{- 1} y\end{matrix} ;$$
therefore, a Gaussian process prediction of the unknown dynamic model μ is:
$${μ}_{GP} ( {ξ}^{*} ) = {μ}_{H , GP} ( {ξ}_{H}^{*} ) + {μ}_{C , GP} ( {ξ}_{c}^{*} ) + {μ}_{f , GP} ( {ξ}_{f}^{*} ) = {\vec{k} ( {ξ}^{*} )}^{T} {( K + {σ}^{2} I )}^{- 1} y ;$$
wherein, μ_{GP}(ξ*) represents the Gaussian prediction value of the unknown dynamic model, and \vec{k}(ξ*) represents a Gaussian prediction variance of the unknown dynamic model; kernel functions
$$k ( {ξ}_{H} , {ξ}_{H}^{′} ) , k ( {ξ}_{C} , {ξ}_{C}^{′} ) , k ( {ξ}_{f} , {ξ}_{f}^{′} )$$
are respectively designed for the inertial force μ_{H}, the Coriolis force μ_{C}, and the frictional force μ_{f} as follows:
$$\{ \begin{matrix}k ( {ξ}_{H} , {ξ}_{H}^{′} ) = {c}_{H} ( {ξ}_{H} ) {\overline{k}}_{H} ( {ξ}_{H} , {ξ}_{H}^{′} ) {c}_{H} ( {ξ}_{H} ) \\ {\overline{k}}_{H} ( {ξ}_{H} , {ξ}_{H}^{′} ) = {σ}_{H}^{2} exp \{ - {( {ξ}_{H} - {ξ}_{H}^{′} )}^{T} {Λ}_{H}^{- 1} ( {ξ}_{H} - {ξ}_{H}^{′} ) \} ; \\ {c}_{H} ( {ξ}_{H} ) = tanh ( {α}_{H}^{2} {‖ {\ddot{q}}_{d} ‖}^{2} )\end{matrix}$$
$$\{ \begin{matrix}k ( {ξ}_{C} , {ξ}_{C}^{′} ) = {c}_{C} ( {ξ}_{C} ) {\overline{k}}_{C} ( {ξ}_{C} , {ξ}_{C}^{′} ) {c}_{C} ( {ξ}_{C} ) \\ {\overline{k}}_{C} ( {ξ}_{C} , {ξ}_{C}^{′} ) = {σ}_{c}^{2} exp \{ - {( {ξ}_{C} - V )}^{T} {Λ}_{C}^{- 1} ( {ξ}_{C} - {ξ}_{C}^{′} ) \} \\ {{{c}_{C} ( {ξ}_{C}^{′} ) = tanh ( {α}_{C}^{2} ‖ \dot{q} ‖}^{2} ‖ {\dot{q}}_{d} ‖}^{2} )\end{matrix} ;$$
$$\{ \begin{matrix}k ( {ξ}_{f} , {ξ}_{f}^{′} ) = {c}_{f} ( {ξ}_{f} ) {\overline{k}}_{f} ( {ξ}_{f} , {ξ}_{f}^{′} ) {c}_{f} ( {ξ}_{f} ) \\ {\overline{k}}_{f} ( {ξ}_{f} , {ξ}_{f}^{′} ) = {σ}_{f}^{2} exp \{ - {( {ξ}_{f} - {ξ}_{f}^{′} )}^{T} {Λ}_{f}^{- 1} ( {ξ}_{f} - {ξ}_{f}^{′} ) \} \\ {c}_{f} ( {ξ}_{f} ) = tanh ( {α}_{f}^{2} ‖ \dot{q} {‖}^{2} )\end{matrix} ;$$
wherein, c_{H}(ξ_{H}),
$${\overline{k}}_{H} ( {ξ}_{H} , {ξ}_{H}^{′} )$$
c_{C}(ξ_{C}),
$${\overline{k}}_{C} ( {ξ}_{C} , {ξ}_{C}^{′} )$$
c_{f}(ξ_{f}) and
$${\overline{k}}_{f} ( {ξ}_{f} , {ξ}_{f}^{′} )$$
all represent intermediate variables, exp{·} represents an exponential function, σ_{H}, Λ_{H} and α_{H} represent hyperparameters of the kernel function corresponding to the inertial force, σ_{C}, Λ_{C} and α_{C} represent hyperparameters of the kernel function corresponding to the Coriolis force, σ_{f}, Λ_{f} and α_{f} represent hyperparameters of the kernel function corresponding to the frictional force.

2. The robot compliance control method with parameter self-learning according to claim 1, wherein the step of constructing a joint dynamics model and a joint impedance control model for a robot, and obtaining an unknown dynamic model of the robot comprises:
constructing the joint dynamics model for the robot with n degrees of freedom as follows:
$$H ( q ) \ddot{q} + C ( q , \dot{q} ) \dot{q} + g ( q ) + {τ}_{f} ( \dot{q} ) = τ + {τ}_{e} ;$$
wherein, q, \dot{q}, \ddot{q}∈Rⁿ respectively represent the position, the velocity, and an acceleration of the robot joint, H(q)∈R_{n×n} represents an inertia matrix of the robot, C(q,\dot{q})∈R^{n×n} represents a Coriolis force and centrifugal force matrix of the robot, g(q)∈Rⁿ represents a gravitational moment of the robot, τ_{f}(\dot{q})∈Rⁿ represents a friction torque of the robot, τ∈Rⁿ, τₑ∈Rⁿ respectively represent the control moment and a contact moment of the robot, Rⁿ represents a n-dimensional vector, R^{n×n} represents a n×n matrix;
constructing the joint impedance control model as follows:
$$\{ \begin{matrix}\overline{H} ë + \overline{D} \dot{e} + \overline{K} e = {τ}_{e} \\ e = q - {q}_{d}\end{matrix} ;$$
wherein, H̅, D̅, K̅ respectively represent an inertia matrix, a damping matrix, and a stiffness matrix in the joint impedance control model; e, ė, ë respectively represent a position error, a velocity error, and an acceleration error of the robot joint; q_{d} represents a desired trajectory of the robot joint; therefore:
$$\ddot{q} = {\overline{H}}^{- 1} ( {τ}_{e} - \overline{K} e - \overline{D} \dot{e} ) + {\ddot{q}}_{d} ;$$
wherein, \ddot{q}_{d} represents a desired acceleration of the robot joint, and an impedance control rate of the robot joint is obtained as follows:
$$\{ \begin{matrix}τ = {τ}_{fb} + {τ}_{ff} \\ {τ}_{fb} = H ( q ) \overline{H} ( {τ}_{e} - \overline{K} e - ( \overline{D} - \overline{H} {H ( q )}^{- 1} C ( q , \dot{q} ) ) \dot{e} ) \\ {τ}_{ff} = g ( q ) + {τ}_{f} ( \dot{q} ) + H ( q ) {\ddot{q}}_{d} + C ( q , \dot{q} ) {\dot{q}}_{d}\end{matrix} ;$$
wherein, τ_{jb}, τ_{ff} respectively represent components containing impedance parameters and the unknown dynamic model, \dot{q}_{d} is the desired velocity of the robot joint; by setting:
$$\{ \begin{matrix}\overline{H} = H ( q ) \\ \overline{D} = C ( q , \dot{q} ) + D \\ \overline{K} = K\end{matrix} ;$$
wherein, D and K are constant matrices, the following formula is obtained:
$${τ}_{fb} = - Ke - D \dot{e} ;$$
wherein, Ĥ(q), Ĉ(q,q), \hat{τ}_{f}(\dot{q}) respectively represent nominal values of H(q),C(q,\dot{q}), τ_{f}(\dot{q}), then τ_{ff} is rewritten as:
$${τ}_{ff} = g ( q ) + \hat{H} ( q ) {\ddot{q}}_{d} + \hat{C} ( q , \dot{q} ) {\dot{q}}_{d} + {\hat{τ}}_{f} ( \dot{q} ) + μ ;$$
wherein, μ represents the unknown dynamic model of the robot, expressed as:
$$\{ \begin{matrix}μ = {μ}_{H} + {μ}_{C} + {μ}_{f} \\ {μ}_{H} = ( H ( q ) - \hat{H} ( q ) ) {\ddot{q}}_{d} \\ {μ}_{C} = ( C ( q , \dot{q} ) - \hat{C} ( q , \dot{q} ) ) {\dot{q}}_{d} \\ {μ}_{f} = {τ}_{f} - {\hat{τ}}_{f}\end{matrix} ;$$
wherein, μ_{H}, μ_{C}, μ_{f} respectively represent an inertial force component, a Coriolis force component, and a frictional force component in the unknown dynamic model of the robot; furthermore, the unknown dynamic model of the robot satisfies the following structure:
$$\{ \begin{matrix}{μ}_{H} ( q , {0}_{n \times 1} ) = {0}_{n \times 1} \\ {μ}_{C} ( q , {0}_{n \times 1} , {\dot{q}}_{d} ) = {μ}_{C} ( q , \dot{q} , {0}_{n \times 1} ) = {0}_{n \times 1} \\ {μ}_{f} ( {0}_{n \times 1} ) = {0}_{n \times 1}\end{matrix} ;$$
from the above formula, when an input \ddot{q}_{d}=0, μ_{H}=0; when \dot{q}_{d}=0 or \dot{q}=0, μ_{C}=0; when \dot{q}=0, μ_{f}==0.

3. The robot compliance control method with parameter self-learning according to claim 1, wherein the step of constructing a training set based on a data optimization method comprises: obtaining the position q, the velocity \dot{q}, and an acceleration \ddot{q} of input data of the robot, and simultaneously obtain output data τ-\hat{τ} of the robot, wherein τ represents the control moment of the robot and \hat{τ} represents a nominal value of the unknown dynamic model;
using the position q as input data of the data optimization method, denoted as Q∈R^{N×n}, wherein N is a data dimension and n is the degree of freedom of the robot, R^{N×n} represents a matrix of N rows and n columns, and transforming a data optimization process into a convex optimization problem as follows:
$${min}_{\hat{Q}} {‖ \hat{Q} - Q ‖}_{F} + {‖ {D}_{1} \hat{Q} {W}_{1} ‖}_{F} + {‖ {D}_{2} \hat{Q} {W}_{2} ‖}_{F} ;$$
wherein, ∥X∥_{F} represents a F norm of a matrix X, \hat{Q} represents a result of noise reduction processing on the input data Q, that is, a position matrix after the noise reduction processing on the input data, and D₁, W₁, D₂,W₂ are intermediate variables with definitions as follows:
$$\{ \begin{matrix}{D}_{1} = [ \begin{matrix}- {I}_{N - 1} & {0}_{( N - 1 ) \times 1} ]\end{matrix} + [ \begin{matrix}{0}_{( N - 1 ) \times 1} & {I}_{N - 1}\end{matrix} ] \\ {D}_{2} = [ \begin{matrix}- {I}_{N - 2} & {0}_{( N - 2 ) \times 2}\end{matrix} ] + [ \begin{matrix}{0}_{( N - 2 ) \times 2} & {I}_{N - 2}\end{matrix} ] + [ {0}_{( N - 2 ) \times 1} - 2 {I}_{N - 2} {0}_{( N - 2 ) \times 1} ] \\ {W}_{1} = diag \{ {ω}_{1} \} , {ω}_{1} ∈ {R}^{n} \\ {W}_{2} = diag \{ {ω}_{2} \} , {ω}_{2} ∈ {R}^{n}\end{matrix} ;$$
wherein, I_{N-1} represents a unit matrix of N−1 dimensions, I_{N-2} represents a unit matrix of N−2 dimensions, Rⁿ represents a n-dimensional vector, and ω₁,ω₂ respectively represents convex optimization parameters; the following formula is obtained through numerical calculation:
$${\hat{Q}}_{: , k} = {( {I}_{N} + {ω}_{1 , k}^{2} {D}_{1}^{T} {D}_{1} + {ω}_{2 , k}^{2} {D}_{2}^{T} {D}_{2} )}^{- 1} {Q}_{: , k} ;$$
wherein, \hat{Q}ᵢₖ represents a k-th column of the position matrix after the noise reduction processing, I_{N} represents the unit matrix of N dimensions, ω_{1,k} represents a k-column of the convex optimization parameter, ω₁, ω_{2,k} represents a k-column of the convex optimization parameter ω₂, and Qᵢₖ represents a k-th column of the input data, and k∈1, . . . , n;
therefore, a velocity matrix \dot{Q}∈R^{(N-1)×n} after the noise reduction processing, and an acceleration matrix \ddot{Q}∈R^{(N-2)×n} after the noise reduction processing, and the obtained training set are respectively expressed as follows:
$$\{ \begin{matrix}\dot{Q} = \frac{1}{T} {D}_{1} \hat{Q} \\ \ddot{Q} = \frac{1}{{T}^{2}} {D}_{2} \hat{Q}\end{matrix} ;$$
$$Ξ = [ \begin{matrix}\hat{Q} & \dot{Q} & \ddot{Q}\end{matrix} ] ;$$
wherein, R^{(N-1)×n} represents a matrix of N−1 rows and n columns, R^{(N-2)×n} represents a matrix of N−2 rows and n columns, Ξ represents the training set, and T represents a sampling period.

4. The robot compliance control method with parameter self-learning according to claim 1, wherein the joint impedance controller of the robot is represented as follows:
$$\{ \begin{matrix}τ = {τ}_{fb} + {τ}_{ff} \\ {τ}_{fb} = - Ke - D \dot{e} \\ {τ}_{ff} = g ( q ) + \hat{H} ( q ) {\ddot{q}}_{d} + \hat{C} ( q , \dot{q} ) {\dot{q}}_{d} + {\hat{τ}}_{f} ( \dot{q} ) + {μ}_{G P} ( {ξ}^{*} )\end{matrix} ;$$
wherein, τ represents the control moment of the robot, τ_{fb}, τ_{ff} are intermediate variables, D and K are constant matrices; e represents the position error of the robot joint, ė represents the velocity error of the robot joint, g(q) represents the gravitational moment of the robot, Ĥ(q) represents the nominal value of the inertia matrix of the robot, \ddot{q}_{d} represents the desired acceleration of the robot joint, Ĉ(q,\dot{q}) represents the nominal value of the Coriolis force and centrifugal force matrix of the robot, \dot{q}_{d} represents the desired velocity of the robot joint, \hat{τ}_{f}(\dot{q}) represents the nominal value of the friction torque of the robot, and μ_{GP}(ξ*) represents the Gaussian prediction value of the unknown dynamic model.

5. A robot compliance control system with parameter self-learning, comprising a Gaussian process construction module, an offline training module, and an online observation control module, wherein:
the Gaussian process construction module is configured to construct a joint dynamics model and a joint impedance control model for a robot, thereby obtaining an unknown dynamic model of the robot; and construct a Gaussian process with a structure consistent with the unknown dynamic model of the robot, denoted as a structure-consistent Gaussian process;
the offline training module is configured to construct a training set based on a data optimization method, and train hyperparameters of the structure-consistent Gaussian process offline using the training set;
the online observation control module is configured to observe a robot state in real-time, predict the unknown dynamic model of the robot online through the structure-consistent Gaussian process, and output a Gaussian prediction value of the unknown dynamic model;
based on the Gaussian prediction value of the unknown dynamic model, output a control moment through a robot joint impedance controller and send the control moment to the robot;
and determine whether the robot has reached a desired position, if yes, ending; otherwise, continuing to observe the robot state;
the structure-consistent Gaussian process of the unknown dynamic model of the robot is constructed as follows:
since an inertial force μ_{H}, a Coriolis force μ_{C}, and a frictional force μ_{f} in the unknown dynamic model of the robot all have n dimensions, n independent Gaussian processes are designed to respectively predict each dimension of μ_{H}, μ_{C}, μ_{f}; three parameters are defined as:
$${ξ}_{H}^{T} = [ \begin{matrix}{q}^{T} & {\ddot{q}}_{d}^{T}\end{matrix} ] ,$$
$${ξ}_{C}^{T} = [ \begin{matrix}{q}^{T} & \dot{q} & {\dot{q}}_{d}^{T}\end{matrix} ] ,$$
and ξ_{f}=\dot{q}, and μ_{H}, μ_{C}, μ_{f} are set to follow the following Gaussian distributions respectively:
$$\{ \begin{matrix}{µ}_{H} ∼ GP ( 0 , k ( {ξ}_{H} , {ξ}_{H}^{′} ) ) \\ {µ}_{C} ∼ GP ( 0 , k ( {ξ}_{C} , {ξ}_{C}^{′} ) ) \\ {µ}_{f} ∼ GP ( 0 , k ( {ξ}_{f} , {ξ}_{f}^{′} ) )\end{matrix} ;$$
wherein, GP(·) represents a Gaussian distribution, T represents a transpose operation of a matrix, q represents a position of a robot joint, \dot{q} represents a velocity of the robot joint, \dot{q}_{d} represents a desired velocity of the robot joint, \ddot{q}_{d} represents a desired acceleration of the robot joint, k(·) represents a variance,
$${ξ}_{H}^{′} ,$$
$${ξ}_{C}^{′} ,$$
$$and$$
$${ξ}_{f}^{′}$$
respectively represent inputs corresponding to the inertial force, the Coriolis force, and the frictional force from the training set,
$$k ( {ξ}_{H} , {ξ}_{H}^{′} )$$
represents a variance of the inertial force in the unknown dynamic model,
$$k ( {ξ}_{C} , {ξ}_{C}^{′} )$$
represents a variance of the Coriolis force in the unknown dynamic model,
$$k ( {ξ}_{f} , {ξ}_{f}^{′} )$$
represents a variance of the frictional force in the unknown dynamic model, and
$$k ( {ξ}_{H} , {ξ}_{H}^{′} ) , k ( {ξ}_{C} , {ξ}_{C}^{′} ) , and k ( {ξ}_{f} , {ξ}_{f}^{′} )$$
are expressed as:
$$\{ \begin{matrix}k ( {ξ}_{H} , {ξ}_{H}^{′} ) = E [ μ ( {ξ}_{H} ) μ ( {ξ}_{H}^{′} ) ] \\ k ( {ξ}_{C} , {ξ}_{C}^{′} ) = E [ μ ( {ξ}_{C} ) μ ( {ξ}_{C}^{′} ) ] \\ k ( {ξ}_{f} , {ξ}_{f}^{′} ) = E [ μ ( {ξ}_{f} ) μ ( {ξ}_{f}^{′} ) ]\end{matrix} ;$$
wherein, E[·] represents a desired value, and μ(·) represents a mean;
the inertial force μ_{H}, the Coriolis force μ_{C}, and the frictional force μ_{f} are set to be mutually independent, that is, a covariance of the inertial force μ_{H}, a covariance of the Coriolis force μ_{C}, and a covariance of the frictional force μ_{f} are set to be all 0:
$$\{ \begin{matrix}Cov ( μ ( {ξ}_{H} ) , μ ( {ξ}_{C} ) ) = E [ μ ( {ξ}_{H} ) μ ( {ξ}_{C}^{′} ) ] = 0 \\ Cov ( μ ( {ξ}_{H} ) , μ ( {ξ}_{f} ) ) = E [ μ ( {ξ}_{H} ) μ ( {ξ}_{f}^{′} ) ] = 0 \\ Cov ( μ ( {ξ}_{C} ) , μ ( {ξ}_{f} ) ) = E [ μ ( {ξ}_{C} ) μ ( {ξ}_{f}^{′} ) ] = 0\end{matrix} ;$$
wherein, Cov(·) represents the covariance, then a variance function of a compensation term μ is:
$$k ( ξ , {ξ}^{′} ) = E [ μ ( ξ ) μ ( {ξ}^{′} ) ] = k ( {ξ}_{H} , {ξ}_{H}^{′} ) + k ( {ξ}_{C} , {ξ}_{C}^{′} ) + k ( {ξ}_{f} , {ξ}_{f}^{′} ) ;$$
wherein, ξ and ξ′ respectively represent an actual input value and an input of the unknown dynamic model from the training set;
Similarly, Cov(μ(ξ_{H}), μ(ξ′)), Cov(μ(ξ_{C}), μ(ξ′), Cov(μ(ξ_{f}), μ(ξ′)) are respectively:
$$\{ \begin{matrix}Cov ( μ ( {ξ}_{H} ) , μ ( {ξ}^{′} ) ) = k ( {ξ}_{H} , {ξ}_{H}^{′} ) \\ Cov ( μ ( {ξ}_{C} ) , μ ( {ξ}^{′} ) ) = k ( {ξ}_{C} , {ξ}_{C}^{′} ) \\ Cov ( μ ( {ξ}_{f} ) , μ ( {ξ}^{′} ) ) = k ( {ξ}_{f} , {ξ}_{f}^{′} )\end{matrix} ;$$
therefore, for a priori ξ*, a joint probability distribution is obtained as follows:
$$p ( [ \begin{matrix}μ ( {ξ}_{H}^{*} ) \\ μ ( {ξ}_{C}^{*} ) \\ μ ( {ξ}_{f}^{*} ) \\ y\end{matrix} ] \vert [ \begin{matrix}{ξ}^{*} \\ Ξ\end{matrix} ] ) = ℕ ( [ \begin{matrix}0 \\ 0 \\ 0 \\ {0}_{N \times 1}\end{matrix} ] , [ \begin{matrix}{k}_{H}^{*} & 0 & 0 & {\vec{k}}_{H} ( {ξ}_{H}^{*} ) \\ 0 & {k}_{C}^{*} & 0 & {\vec{k}}_{C} ( {ξ}_{C}^{*} ) \\ 0 & 0 & {k}_{f}^{*} & {\vec{k}}_{f} ( {ξ}_{f}^{*} ) \\ {\vec{k}}_{H} ( {ξ}_{H}^{*} ) & {\vec{k}}_{C} ( {ξ}_{C}^{*} ) & {\vec{k}}_{f} ( {ξ}_{f}^{*} ) & K + {σ}^{2} I\end{matrix} ] ) ;$$
wherein, p(·) represents a probability,
$${ξ}_{H}^{*}$$
represents a priori of the inertial force of the unknown dynamic model,
$${ξ}_{C}^{*}$$
represents a priori of the Coriolis force of the unknown unknown dynamic model, dynamic model,
$${ξ}_{f}^{*}$$
represents a priori of the frictional force of the unknown dynamic model,
$$μ ( {ξ}_{H}^{*} )$$
is a mean of the priori of the inertial force,
$${ξ}_{H}^{*}$$
represents a mean of the priori of the Coriolis force,
$$μ ( {ξ}_{C}^{*} )$$
represents a mean of the priori of the frictional force, Ξ represents the training set, y represents an output, [symbol] represents the Gaussian distribution, N represents a length of position data of the robot,
$${k}_{H}^{*} , {k}_{f}^{*} and {k}_{C}^{*}$$
respectively represent priori kernel function values corresponding to the inertial force, the Coriolis force, and the frictional force;
$${\vec{k}}_{H} ( {ξ}_{H}^{*} ) , {\vec{k}}_{C} ( {ξ}_{C}^{*} ) , and {\vec{k}}_{f} ( {ξ}_{f}^{*} )$$
respectively represent kernel function vectors corresponding to the inertial force, the Coriolis force, and the frictional force, K represents a kernel function matrix, σ represents a noise variance, I represents an identity matrix,
$${k}_{H}^{*} {=}^{△} k ( {ξ}_{H}^{*} , {ξ}_{H}^{*} ) , {{\vec{k}}_{H} ( {ξ}_{H}^{*} )}_{i} = k ( {ξ}_{H}^{*} , {ξ}_{i} ) ,$$
ξᵢ represents i-th data in the training set,
$${{\vec{k}}_{H} ( {ξ}_{H}^{*} )}_{i}$$
represents the kernel function value corresponding to ξᵢ, and Ξ represents the training set, thus:
$$p ( [ \begin{matrix}μ ( {ξ}_{H}^{*} ) \\ μ ( {ξ}_{C}^{*} \\ μ ( {ξ}_{f}^{*}\end{matrix} ] ξ , y , Ξ ) = ℕ ( [ \begin{matrix}{μ}_{H , GP} ( {ξ}_{H}^{*} ) \\ {μ}_{C , GP} ( {ξ}_{C}^{*} ) \\ {μ}_{f , GP} ( {ξ}_{f}^{*} )\end{matrix} ] , {σ}_{GP , HCf}^{2} ( {ξ}^{*} ) ) ;$$
wherein,
$${μ}_{H , GP} ( {ξ}_{H}^{*} )$$
represents a Gaussian prediction value of the inertial force in the wherein, unknown dynamic model,
$${μ}_{C , GP} ( {ξ}_{C}^{*} )$$
represents a Gaussian prediction value of the Coriolis force in the unknown dynamic model,
$${μ}_{f , GP} ( {ξ}_{f}^{*} )$$
represents a Gaussian prediction value of the frictional force in the unknown dynamic model,
$${σ}_{GP , HCf}^{2} ( {ξ}^{*} )$$
represents the joint variance, wherein:
$$\{ \begin{matrix}{μ}_{H , GP} ( {ξ}_{H}^{*} ) = {{\vec{k}}_{H} ( {ξ}_{H}^{*} )}^{T} {( K + {σ}^{2} I )}^{- 1} y \\ {μ}_{C , GP} ( {ξ}_{C}^{*} ) = {{\vec{k}}_{C} ( {ξ}_{C}^{*} )}^{T} {( K + {σ}^{2} I )}^{- 1} y \\ {μ}_{f , GP} ( {ξ}_{f}^{*} ) = {{\vec{k}}_{f} ( {ξ}_{f}^{*} )}^{T} {( K + {σ}^{2} I )}^{- 1} y\end{matrix} ;$$
therefore, a Gaussian process prediction of the unknown dynamic model μ is:
$${μ}_{GP} ( {ξ}^{*} ) = {μ}_{H , GP} ( {ξ}_{H}^{*} ) + {μ}_{C , GP} ( {ξ}_{C}^{*} ) + {μ}_{f , GP} ( {ξ}_{f}^{*} ) = {\overline{k} ( {ξ}^{*} )}^{T} {( K + {σ}^{2} I )}^{- 1} y ;$$
wherein, μ_{GP}(ξ*) represents the Gaussian prediction value of the unknown dynamic model, and \hat{k}(ξ*) represents a Gaussian prediction variance of the unknown dynamic model; kernel functions
$$k ( {ξ}_{H} , {ξ}_{H}^{′} ) , k ( {ξ}_{C} , {ξ}_{C}^{′} ) , k ( {ξ}_{f} , {ξ}_{f}^{′} )$$
are respectively designed for the inertial force μ_{H}, the Coriolis force μ_{C}, and the frictional force μ_{f} as follows:
$$\{ \begin{matrix}k ( {ξ}_{H} , {ξ}_{H}^{′} ) = {c}_{H} ( {ξ}_{H} ) {\overline{k}}_{H} ( {ξ}_{H} , {ξ}_{H}^{′} ) {c}_{H} ( {ξ}_{H} ) \\ {\overline{k}}_{H} ( {ξ}_{H} , {ξ}_{H}^{′} ) = {σ}_{H}^{2} exp \{ - {( {ξ}_{H} - {ξ}_{H}^{′} )}^{T} {Λ}_{H}^{- 1} ( {ξ}_{H} - {ξ}_{H}^{′} ) \} \\ {c}_{H} ( {ξ}_{H} ) = tanh ( {α}_{H}^{2} {‖ {\ddot{q}}_{d} ‖}^{2} )\end{matrix} ;$$
$$\{ \begin{matrix}k ( {ξ}_{C} , {ξ}_{C}^{′} ) = {c}_{C} ( {ξ}_{C} ) {\overline{k}}_{C} ( {ξ}_{C} , {ξ}_{C}^{′} ) {c}_{C} ( {ξ}_{C} ) \\ {\overline{k}}_{C} ( {ξ}_{C} , {ξ}_{C}^{′} ) = {σ}_{C}^{2} exp \{ - {( {ξ}_{C} - {ξ}_{C}^{′} )}^{T} {Λ}_{C}^{- 1} ( {ξ}_{C} - {ξ}_{C}^{′} ) \} \\ {c}_{C} ( {ξ}_{C} ) = tanh ( {α}_{C}^{2} {‖ \dot{q} ‖}^{2} {‖ {\dot{q}}_{d} ‖}^{2} )\end{matrix} ;$$
$$\{ \begin{matrix}k ( {ξ}_{f} , {ξ}_{f}^{′} ) = {c}_{f} ( {ξ}_{f} ) {\overline{k}}_{f} ( {ξ}_{f} , {ξ}_{f}^{′} ) {c}_{f} ( {ξ}_{f} ) \\ {\overline{k}}_{f} ( {ξ}_{f} , {ξ}_{f}^{′} ) = {σ}_{f}^{2} exp \{ - {( {ξ}_{f} - {ξ}_{f}^{′} )}^{T} {Λ}_{f}^{- 1} ( {ξ}_{f} - {ξ}_{f}^{′} ) \} \\ {c}_{f} ( {ξ}_{f} ) = tanh ( {α}_{f}^{2} {‖ \dot{q} ‖}^{2} )\end{matrix} ;$$
wherein, c_{H}(ξ_{H}),
$${\overline{k}}_{H} ( {ξ}_{H} , {ξ}_{H}^{′} ) ,$$
c_{C}(ξ_{C}),
$${\overline{k}}_{C} ( {ξ}_{C} , {ξ}_{C}^{′} ) ,$$
c_{f}(ξ_{f}) and
$${\overline{k}}_{f} ( {ξ}_{f} , {ξ}_{f}^{′} )$$
all represent intermediate variables, exp{·} represents an exponential function, σ_{H}, Λ_{H} and α_{H} represent hyperparameters of the kernel function corresponding to the inertial force, σ_{C}, Λ_{C} and α_{C} represent hyperparameters of the kernel function corresponding to the Coriolis force, σ_{f}, Λ_{f} and α_{f} represent hyperparameters of the kernel function corresponding to the frictional force.

6. A robot compliance control apparatus with parameter self-learning, comprising a processor and a memory storing a plurality of computer instructions, wherein, when being executed by the processor, the computer instructions implement the steps of the robot compliance control method with parameter self-learning according to claim 1.

7. A robot compliance control apparatus with parameter self-learning, comprising a processor and a memory storing a plurality of computer instructions, wherein, when being executed by the processor, the computer instructions implement the steps of the robot compliance control method with parameter self-learning according to claim 2.

8. A robot compliance control apparatus with parameter self-learning, comprising a processor and a memory storing a plurality of computer instructions, wherein, when being executed by the processor, the computer instructions implement the steps of the robot compliance control method with parameter self-learning according to claim 3.

9. A robot compliance control apparatus with parameter self-learning, comprising a processor and a memory storing a plurality of computer instructions, wherein, when being executed by the processor, the computer instructions implement the steps of the robot compliance control method with parameter self-learning according to claim 4.
